(19) United States
(12) Patent Application Publication
(10) Pub. No.: US 2017/0344991 A1
(43) Pub. Date: Nov. 30, 2017

(54) USER CONTROLLED REMOTE CREDIT AND BANK CARD TRANSACTION VERIFICATION SYSTEM

(71) Applicants: Shlomo MARK, Jerusalem (IL); Yitzchok SCHWARTZ, Monroe, NY (US)

(72) Inventors: Shlomo MARK, Jerusalem (IL); Yitzchok SCHWARTZ, Monroe, NY (US)

(21) Appl. No.: 15/525,882

(22) PCT Filed: Nov. 10, 2015
(86) PCT No.: PCT/IB2015/002211

§ 371 Date: May 10, 2017

Related U.S. Application Data
(60) Provisional application No. 62/077,722, filed on Nov. 10, 2014.

(51) Int. Cl. G06Q 20/40; G06Q 20/42; G06F 17/30

(52) U.S. Cl. CPC G06Q 20/401; G06F 17/30227; G06Q 20/425

(57) ABSTRACT

Systems and methods are presented for preventing the illegal use of credit, ATM or bank cards or the accounts with which they are associated. In exemplary embodiments of the present invention, a user configured approval functionality may be provided that subjects every non-exempted transaction to user approval. A smartphone application may also be provided, in which a user sets and modifies parameters for covered transactions, and may approve or deny any transaction subject to a prior approval requirement. Systems and methods according to the present invention may be applied to cards and similar payment devices of any and all types, including, for example, credit cards, bank cards, ATM cards, retailer specific cards, government issued food stamp or other welfare cards, gift cards, and the like. Thus, a user may register multiple payment cards with such an application, and thus set and modify his or her own criteria (in addition to or in place of default criteria) for flagging transactions made with the cards for approval.

### CROSS-REFERENCE TO RELATED APPLICATIONS

The present application claims the benefit of, and priority to, U.S. Provisional Patent Application No. 62/077,722, filed on Nov. 10, 2014, entitled “USER CONTROLLED REMOTE CREDIT AND BANK CARD TRANSACTION VERIFICATION SYSTEM”, which is hereby incorporated herein by reference as if fully set forth.

### TECHNICAL FIELD

The present invention generally relates to credit and other payment card fraud prevention, and in particular to systems and methods for facilitating granular verification of transactions where payment is made using credit cards, debit cards, bank cards or similar payment instruments.

### BACKGROUND OF THE INVENTION

Every day hundreds of credit cards, ATM cards, bank account access cards and the like are stolen or lost. Alternatively, even when the actual card remains in its owners' possession, numbers may be stolen and used, often by unscrupulous persons who, once obtaining the card information, process payment with the same cards. This can even happen when the card holder has uninterrupted physical possession of the card. For example, as reported in Forbes on Jan. 30, 2012, available at the following URL http://www.forbes.com/sites/andygreenberg/2012/01/30/hackers-demo-shows-how-easily-credit-cards-can-be-read-through-clothes-and-wallets/, if the back of a credit card is marked with the words “PayPass,” “Blink,” that triangle of nested arcs that serves as the universal symbol for wireless data, or a few other obscure icons, Kristin Paget says it is vulnerable to an uber-stealthy form of pickpocketing. As she showed on a Washington D.C. stage, one can read all the data one needs to make a fraudulent transaction off that card with just a few hundred dollars worth of equipment, and do it invisibly through your wallet, purse, or pocket.

In this type of fraud as well as others, due to the lapse of time between the actual loss or theft of the card or the card information, and its discovery and ultimate reporting to the bank or card issuer, many fraudulent transactions can occur, and in the aggregate these can add up to millions of dollars per month. Because each card issuer remains responsible for these charges, and not the actual cardholder, the issuing banks or retailers must absorb this cost, and accordingly must pass it through to their legitimate customers.

Thus, any significant curbing of fraudulent transactions using payment or bank cards of whatever type serves to reduce costs to all consumers of such payment instruments. Moreover, whenever a fraud does occur, a cardholder must notify the card issuer, check all transactions to see if they are legitimate, and generally take a few hours of stress-filled research to resolve the problem. Thus, any solution to such fraudulent charges would serve to save significant time, reduce stress, and, if implemented so as to flag the user or issuer at the first attempted fraudulent use of the card, can cut off any fraudulent transactions before they occur.

Generally, a card issuer controls fraud detection for its cards and payment products. Thus, a user or cardholder does not have any choice in what filters, rules, or algorithms are applied. Nor does the cardholder have any say in which potentially suspect transactions are sent to him or her for approval. A user may want to specifically filter purchases made during a given temporal window, geographical area, or by additional cardholders on a given payment card for viewing and approval. He or she may want to apply such filters to some or all of the payment cards he has or guarantees. Conventionally there is no way for a user to take over such control, and centralize his approval of potentially suspicious transactions.

What are thus needed in the art are systems, devices and methods that allow a cardholder or card guarantor to set parameters as to when a transaction is flagged, and under what circumstances it is to be reported for approval or further inquiry.

### SUMMARY OF THE INVENTION

Systems and methods are presented for preventing the illegal, illicit or unauthorized use of credit, ATM or bank cards, or the accounts with which they are associated. In exemplary embodiments of the present invention, a user configured approval functionality may be provided that subjects every non-exempted transaction to user approval. A smartphone application may also be provided, in which a user sets and modifies parameters for covered transactions, and may manually approve or deny any transaction subject to a prior approval requirement. Systems and methods according to the present invention may be applied to cards and similar payment devices of any and all types, including, for example, credit cards, bank cards, ATM cards, retailer specific cards, government issued food stamp or other welfare cards, gift cards, and the like. Thus, a user may register multiple payment cards with such an application, and thus set and modify his or her own criteria for flagging transactions made with the cards for approval.

### BRIEF DESCRIPTION OF THE DRAWINGS

FIG. 1A shows an exemplary system in accordance with various embodiments of the present invention;

FIG. 1B illustrates exemplary process flow according to an exemplary embodiment of the present invention;

FIG. 1C shows an alternate exemplary system in accordance with various embodiments of the present invention;

FIG. 2 illustrates a screen shot of an exemplary linking of a payment card to a user, and printing of a QR form according to an exemplary embodiment of the present invention;

FIG. 3 illustrates a exemplary QR form according to an exemplary embodiment of the present invention;

FIG. 4 is an exemplary screen shot used to associate a card with a smartphone application according to an exemplary embodiment of the present invention;

FIG. 5 illustrates an exemplary purchase screen, showing various stores, according to an exemplary embodiment of the present invention;

FIG. 6 is an exemplary card registration screen within a smartphone application according to an exemplary embodiment of the present invention;

FIG. 7 is an exemplary purchase approval request screen shot on a merchant's side, here for an exemplary 1000 shekel purchase at a Ked's Kids store;

FIG. 8 illustrates an exemplary cardholder purchase approval screen, where the cardholder is prompted to enter the secret code, according to an exemplary embodiment of the present invention;

FIG. 9 illustrates how once the cardholder has approved the purchase via his smart phone, the merchant receives a credit authorization via a Credit Console (assuming the transaction is otherwise approved in terms of the credit card company);

FIG. 10 illustrates an exemplary indication of approval of the transaction screen shown to the cardholder within the smartphone application;

FIG. 11 illustrates messaging between a transaction acquirer or merchant, a card issuer, and an exemplary authorization server according to an exemplary embodiment of the present invention;

FIG. 12 illustrates an exemplary use scenario where a transaction is manually approved according to an exemplary embodiment of the present invention;

FIG. 13 illustrates an exemplary use scenario where a transaction is automatically declined based on the cardholder not being in proximity of the merchant according to an exemplary embodiment of the present invention;

FIG. 14 illustrates an exemplary use scenario where a transaction is automatically approved as being on the cardholder's whitelist (transactions/merchants not requiring manual approval of cardholder); and

FIG. 15 illustrates an exemplary use scenario where a transaction is automatically approved as falling within a temporally limited “up to a maximum” pre-approval rule according to an exemplary embodiment of the present invention.

### DETAILED DESCRIPTION OF THE INVENTION

Methods, systems, and computer readable media for a user configured credit or payment card transaction approval functionality are provided that subjects every non-exempted transaction to user approval. This functionality may be integrated into an existing fraud detection and cardholder warning system or service, such as those currently used by banks, card issuers, retailers and the like, or it may be provided as a separate application, or as one of many features in a separate application providing enhanced fraud detection services.

An exemplary user side application may run on a user device, such as, for example, a smartphone, and may access a user's account with a card issuer and thus the card issuer's remote server or servers. Alternatively, a third party fraud detection and transaction approval company or service may have its own servers, and it may operate independently of, but in co-ordination with, various card issuers.

It is noted that the terms “device,” “mobile device,” “client device,” and “content management system” are used herein to refer broadly to a wide variety of storage providers and data management service providers, electronic devices and mobile devices, as well as to a wide variety of types of content, files, portions of files, and/or other types of data. The term “user” is also used herein broadly, and may correspond to a single user, multiple users, authorized accounts, an application or program operating automatically on behalf of, or at the behest of a person, or any other user type, or any combination thereof. The term “gesture” and “gestures” are also used herein broadly, and may correspond to one or more motions, movements, hoverings, inferences, signs, or any other such physical interactions with one or more sensors, or any combination thereof, including vocal commands or interpretations of eye movements based on retinal tracking.

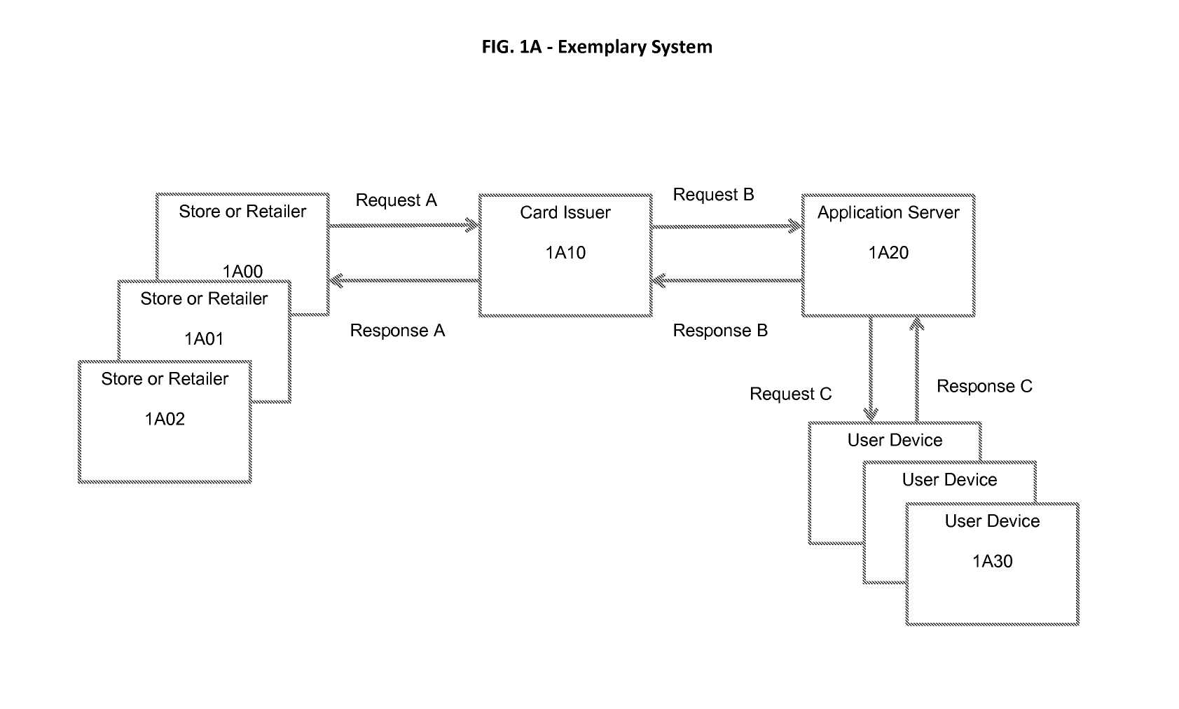

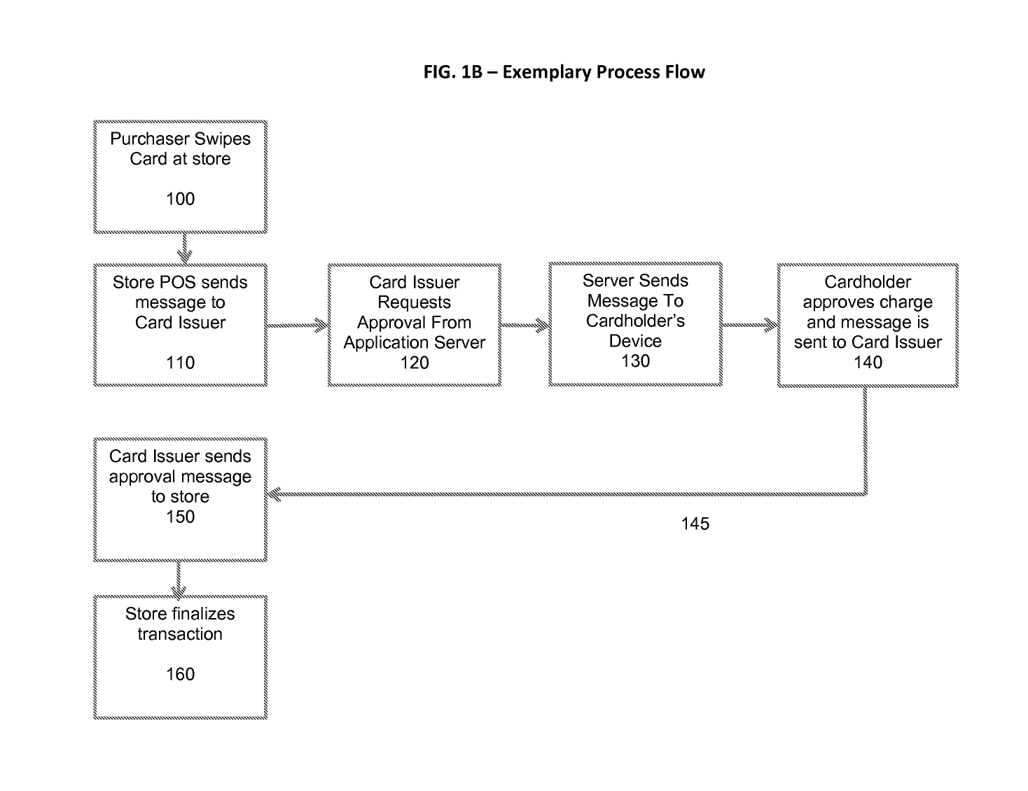

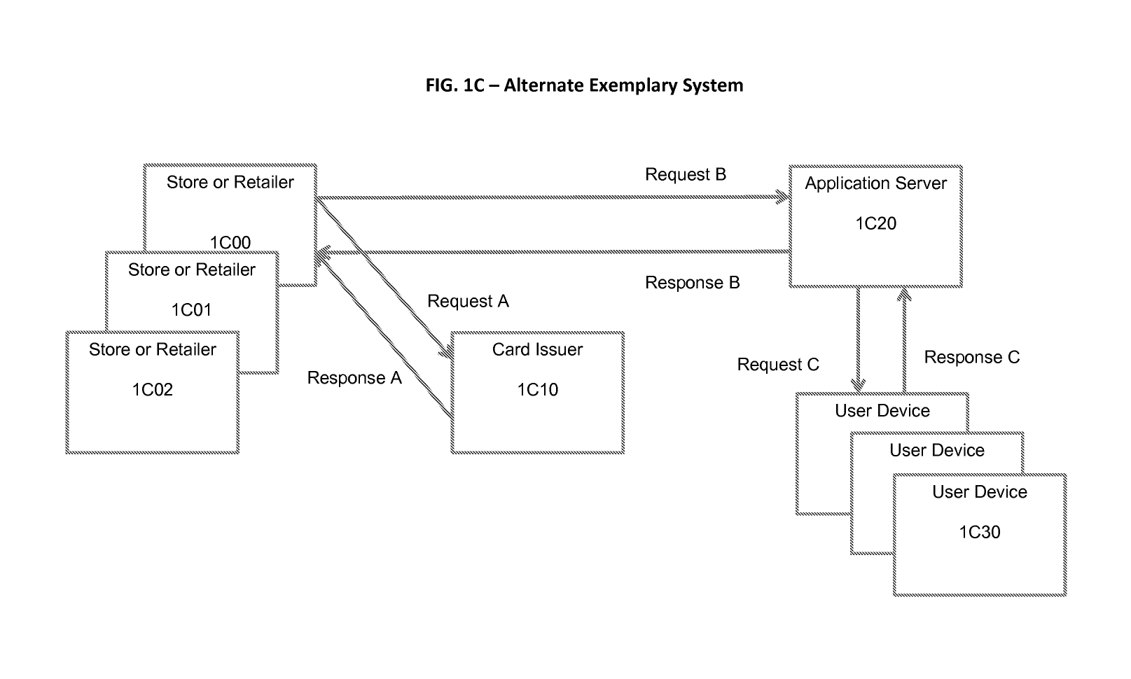

Various types of user devices may include, but are not limited to, smart phones, mobile phones, tablet computers, personal digital assistants (PDAs), laptop computers, desktop computers, digital music players, and/or any other type of user device capable of including a touch-sensing display interface or other user interface. Various touch-sensing display interfaces may include, but are not limited to, liquid crystal displays (LCD), monochrome displays, color graphics adapter (CGA) displays, enhanced graphics adapter (EGA) displays, variable-graphics array (VGA) displays, or any other display, or any combination thereof. In some embodiments, the touch-sensing display interface may include a multi-touch panel coupled to one or more processors to receive and detect gestures. Multi-touch panels, for example, may include capacitive sensing mediums having a one or more of row traces and/or driving line traces, and one or more column traces and/or sensing lines. Although multi-touch panels are described herein as one example for touch-sensing display interface, persons of ordinary skill in the art will recognize that any touch-sensing display interface may be used. Furthermore, various types of user devices may, in some embodiments, include one or more image capturing components (e.g., a camera). For example, user devices (1A30 in FIG. 1A) may include a front-facing camera and/or a rear facing camera.

The present invention may take form in various components and arrangements of components, and in various techniques, methods, or procedures and arrangements of steps. The referenced drawings are only for the purpose of illustrating embodiments, and are not to be construed as limiting the present invention. Various inventive features are described below that may each be used independently of one another or in combination with other features.

FIG. 1A shows an exemplary system in accordance with various embodiments. Elements in FIG. 1, including, but not limited to, a user electronic device 1A30, a fraud detection and approval system Application Server 1A20, and retailers or other commercial entities 1A00-1A02 that accept payments via a payment card or the like. These devices may communicate by sending and/or receiving data over a network. The network may be any network, combination of networks, or network devices that may carry data communication. For example, the network may be any one or any combination of LAN (local area network), WAN (wide area network), telephone network, wireless network, point-to point network, star network, token ring network, hub network, or any other configuration.

Moreover, the network may support any number of protocols, including but not limited to TCP/IP (Transfer Control Protocol and Internet Protocol), HTTP (Hypertext Transfer Protocol), WAP (wireless application protocol), etc. For example, client USER devices 1A30-1A33 may communicate with fraud detection and approval system Application Server 1A20 using TCP/IP, and, at a higher level, use a browser to communicate with a web server (not shown) at fraud detection and approval system using HTTP. Example browsers may include, but are not limited to, Google Inc. Chrome™ browser, Microsoft Internet Explorer®, Apple Safari®, Mozilla Firefox, and Opera Software Opera.

With reference to FIG. 1A, it is understood that various alternate systems may be implemented, all of which are within the scope of the present invention. Shown at the far left of FIG. 1A is plurality of stores or retailers 1A00, 1A01, and 1A02. Although for purposes of illustration the number of stores or retailers, and the number of user devices connected to an exemplary system, are shown as limited to three, in the real world it is understood that hundreds of thousands, and even millions of merchants, as well as an equal or larger number of user devices may easily be involved in exemplary system according to an embodiment of the present invention.

Store or retailers 1A00 through 1A02 are approached either in person or online by a purchaser who wishes to make a purchase, or undertake a transaction, using a credit card or the equivalent. In general, such a user either gives the credit card to a clerk or a cashier, for example, or swipes the card himself at a point of sale machine (“POS device”). Once the credit card is read by the merchant's payment system, a request is sent to the card issuer for approval. This is indicated in FIG. 1A as Request A, and is common in conventional credit card approval systems as are in use today. Card issuer 1A10 receives the request, and normally would run its own vetting software to check for any number of red flags indicating fraud. If there is nothing to be suspicious of, Card Issuer 1A10 would then send a response back to the store or retailer approving the charge. This is indicated in FIG. 1A as “Response A.” Once the store or retailer, for example, store or retailer 1A00, receives Response A the words “approved” will either flash on the POS device or some other message will appear within the cashier's computer, and the purchase will be completed. However, in exemplary embodiments of the present invention an additional set of steps may occur in which the fraud prevention steps of exemplary embodiments of the present invention are implemented. These are shown on the right side of FIG. 1A.

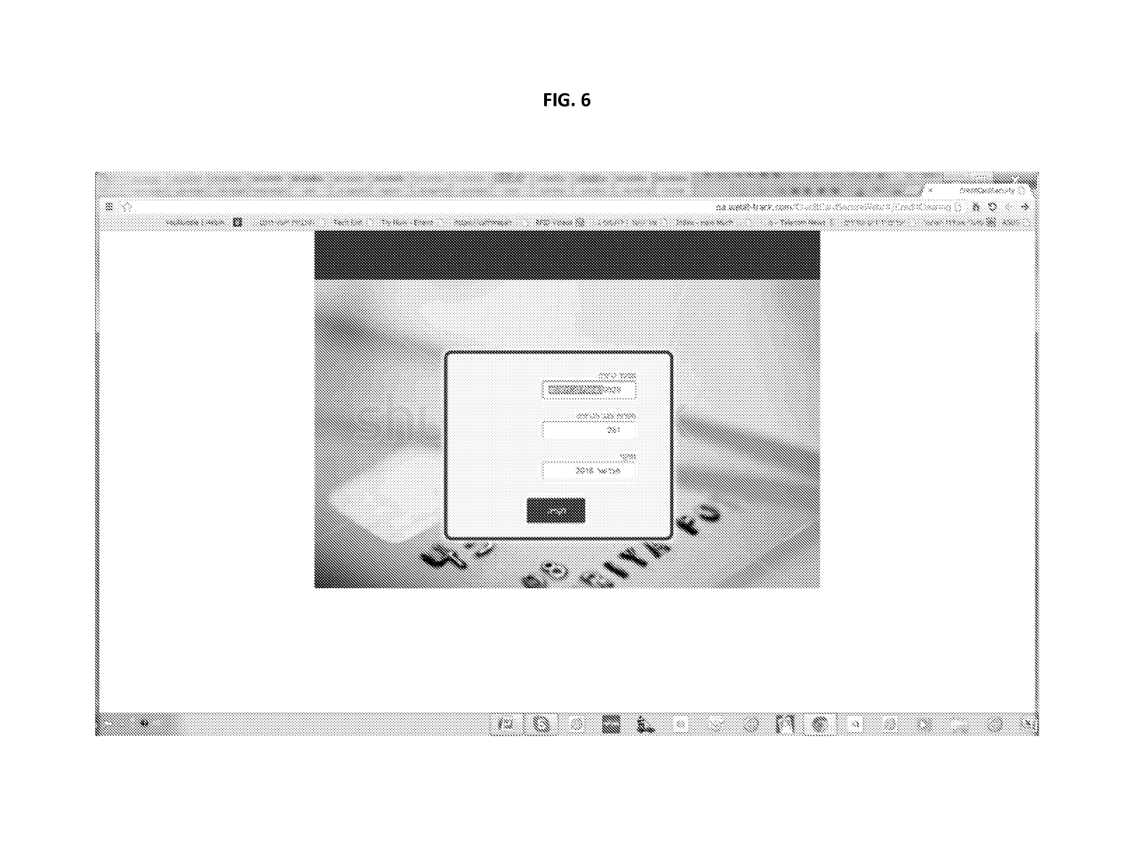

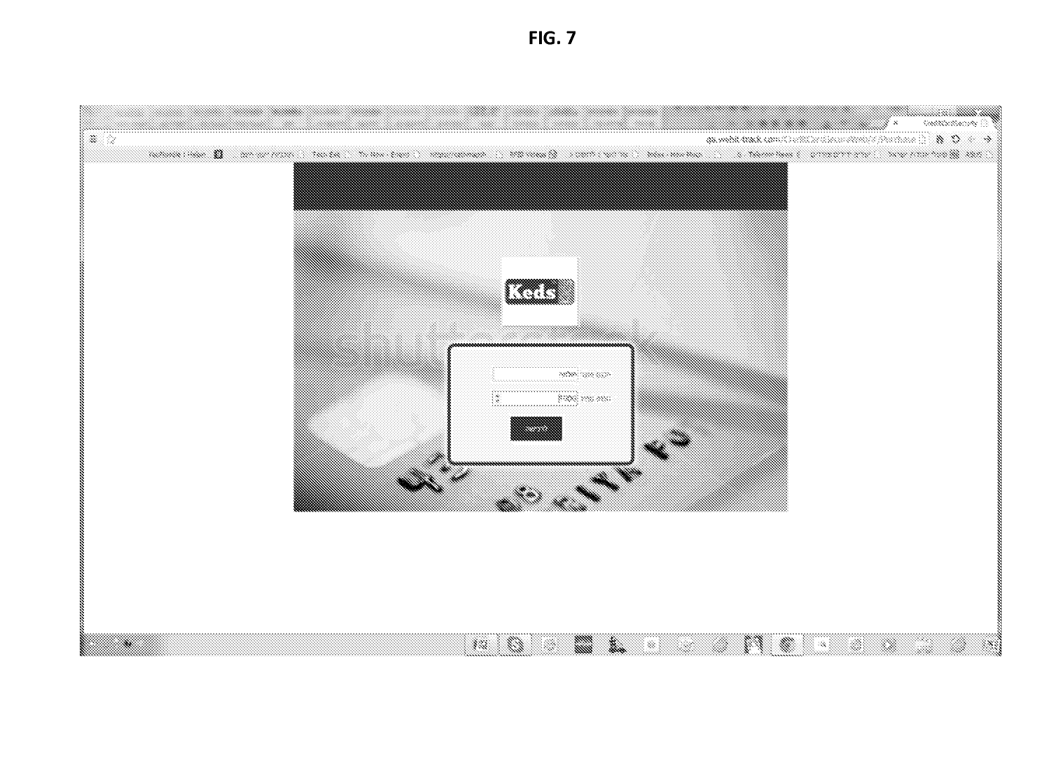

Thus, once Card Issuer 1A10 receives Request A from a store or retailer, Card Issuer 1A10 sends an additional request—denoted as “Request B” in FIG. 1A—to an Application Server 1A20. The Application Server is provided with software and hardware allowing it to implement various aspects of the present invention. In particular, Application Server 1A20 may be arranged to determine whether the proposed charge on the proposed credit card, or other payment card, falls within an automatic approval category or within one of several “requires card holder approval” categories. If the latter, the application server sends a third request, denoted as “Request C” in FIG. 1A, to a User Device, such as User devices 1A30 through 1A32 as shown in FIG. 1A. The user device may run an application that has registered the particular credit card (either via that User Device, or another). Given that the charge is one that the application running on Application Server 1A20 determines must be sent to the user for physical approval, the user is requested to approve the charge as shown in FIGS. 6 and 7, as further described below.

Once the user sees the charge on his or her mobile or user device 1A30, he can, by entering the secret code, as more fully described below, approve the charge. The User Device may then send a response to Application Server 1A20. This response is denoted “Response C” in FIG. 1A. Upon receipt of Response C, Application Server 1A20 then may send Response B to the card issuer's computer 1A10, which in turn may send an approval message “Response A” to store or retailer 1A00-1A02, as the case may be.

In the event that a card holder does not respond with a User Device to Request C, and thus no Response C is ever received by the Application Server, a potential time out situation exists. This may be handled in various ways. A time limit may be set by a merchant, i.e., how long they are willing to wait. Similarly, a time limit may also be set by the system, or none may be set, where approval has no time limitation. Thus, when the store cancels the transaction on their end it will automatically be void. Alternatively, other messages may be sent to the user, such as via email, voice message, SMS, messaging within various other applications that may be available on a user device (e.g., FaceBook), etc.

It is understood that although they are depicted in FIG. 1A as two separate modules, Card Issuer 1A10 and Application Server 1A20 may, in some exemplary embodiments, be combined into one physical or logical server such as, for example, where the application according to exemplary embodiments of the present invention is integrated with a card issuer's (e.g., bank's) standard approval process, and software implementing the present charge approval functionality is integrated in the card issuer's existing systems.

Thus, in some embodiments, an API may be developed for creating a link between a card issuer and a card holder. Such an API may be installed on any server, such as a bank's (e.g., Card Issuer 1A10) server, or any other server, such as, for example, Amazon EC2.

In various exemplary embodiments, User Devices may include a variety of client electronic devices including, but not limited to, desktop computers, mobile computers, mobile communication devices (e.g., mobile phones, smart phones, tablets), televisions, set-top boxes, and/or any other network enabled device. Although three exemplary client electronic devices 1A30-1A32 are illustrated in FIG. 1 for ease of description, persons of ordinary skill in the art will recognize that any number of devices may be used and supported by an exemplary fraud detection and approval system, including multiple devices per card holder, and a large population of card holders. Thus, in a real world implementation it is expected that these will number into the millions.

In exemplary embodiments of the present invention, a smartphone application may be provided on User Device 1A30, in which a user sets (and modifies) parameters and filters for covered transactions, and may approve or deny any transaction subject to a prior approval requirement. In exemplary embodiments of the present invention, the system and methods of the present invention may be applied to cards and similar payment devices of any and all types, including, for example, credit cards, bank cards, ATM cards, retailer specific cards, government issued food stamp or other welfare cards, gift cards, and the like.

Various exemplary embodiments of the present invention can prevent the illegal use of cards and account information. In some embodiments, application screens may be displayed matching engine advertising according to location and type of previous acquisitions, other geo-locational parameters, or the like.

Given an exemplary system such as is depicted in FIG. 1A, FIG. 1B illustrates an exemplary process flow according to some exemplary embodiments of the present invention. Beginning at 100, a purchase swipes his or her card at a store or merchant, such as Store Or Retailer 1A00 in FIG. 1A. From there process flow moves to 110 where the point of sale device in the store sends a message to the Card Issuer, e.g., a bank, requesting approval. The Card Issuer than requests approval from an Application Server at 120, the Application Server being a server such as Application Server 1A20 in FIG. 1A. From 120, process flow moves to 130 where the Server sends a message to the card holder's device; at 140 the card holder approves the charge and an approval message is sent back to the Card Issuer, along path 145. From there process flow moves to 150, where the Card Issuer, now having received the approval from the card holder (such as, for example, by entering the secret code on the user device), now sends an approval message to the store at 150. At 160, having received the approval message from the card issuer, the Store than finalizes the transaction.

In exemplary embodiments of the present invention, the linking of a given card to the user application may be made upon issuance of the card, by the bank or card issuer, or, for example, by a user, after receipt. For example, this may be done using a process described below, involving, for example, scanning a QR code to be attached to all new credit cards. In this connection it is noted that a QR code, or “Quick Response” code is a squarish, two-dimensional barcode that can be scanned into and read by electronic devices. Originally designed as a way to track vehicles on the assembly line, QR codes are being used today in conjunction with smartphone cameras to obtain coupons or make purchases via credit card.

It is understood, however, that many credit cards, payment cards, insurance cards, and the like, do not have QR codes. In alternate embodiments, if a card issuer decides to offer the fraud control benefits of the present invention it may send a QR sticker to each cardholder subscribing to the service, or all cardholders, if the card issuer is simply providing the service generically, to be affixed to the card for easy linking with the application. Alternatively, other methods of linking cards may be used, such as, for example, taking a photograph of the card by the user with the user device, and using image recognition to extract the card number and security code, for example.

Additionally, for example, Near Field Communication (“NFC”) technology may be utilized. In this regard it is noted that most of the newer smart phones and similar devices contain a NFC reader which can be used to register a card, using an exemplary application stored on a user device.

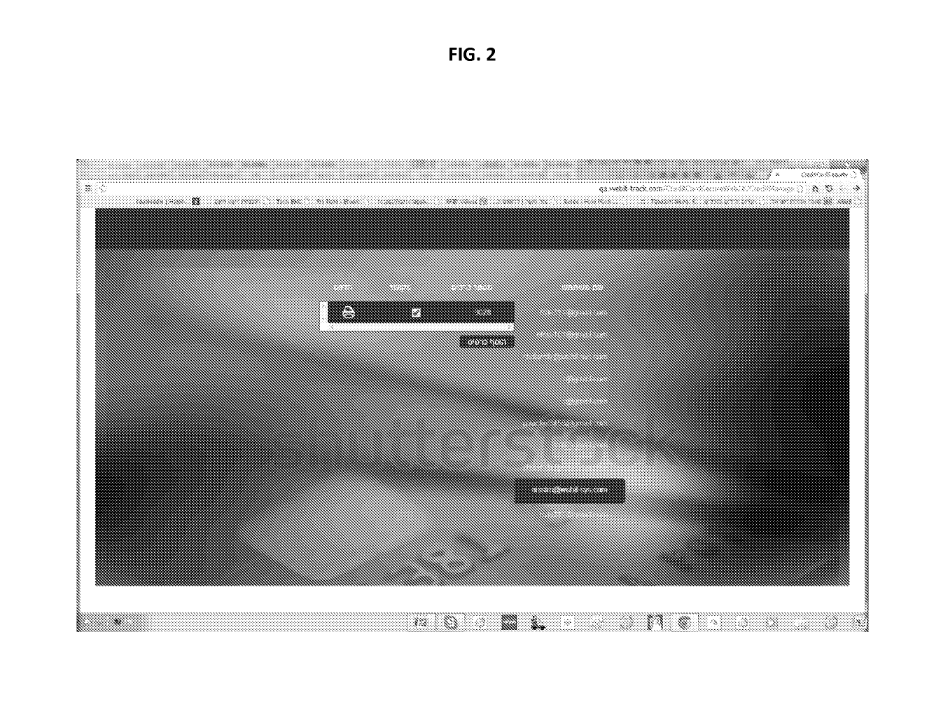

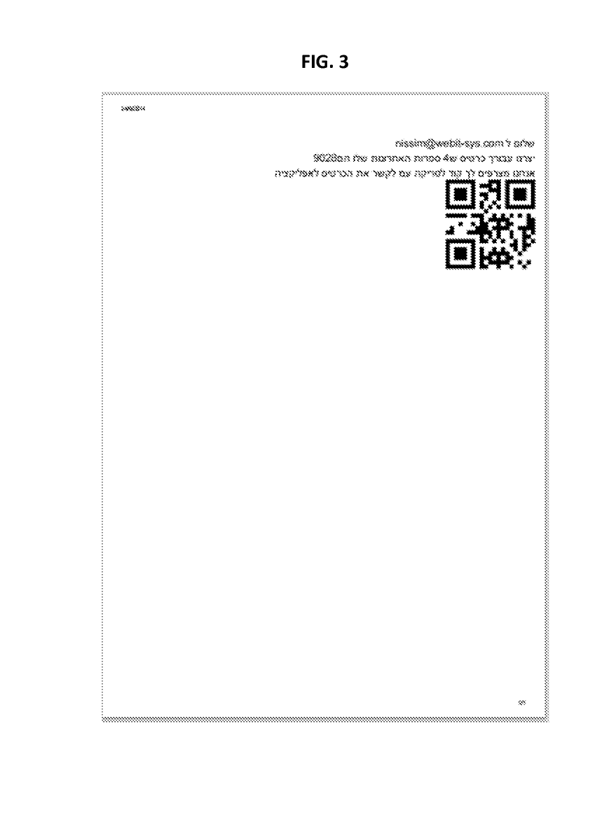

FIG. 2 illustrates a screen shot of such an exemplary linking of a payment card to a user, and the printing of a QR form for affixing to the card according to an exemplary embodiment of the present invention, and FIG. 3 illustrates a exemplary QR form that may be used, for example. In exemplary embodiments of the present invention, a card issuer, such as, for example, a credit card company, may either send a QR to a card holder, or send a card number, such as the last four digits of the card, in case a user has more than one card linked to the application from that card issuer.

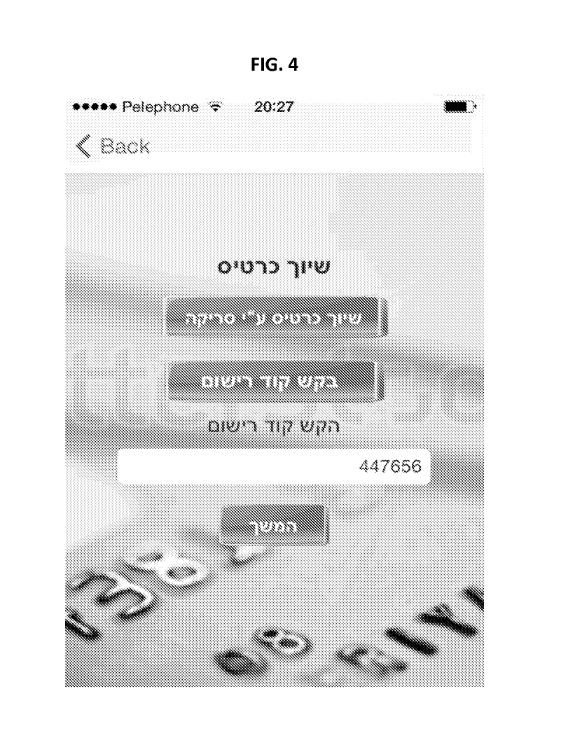

FIG. 4 is an exemplary screen shot used to associate a card with a smartphone application according to an exemplary embodiment of the present invention that may be provided to a user within an exemplary application on a user device. It says in Hebrew “register a card” at the top, and in the first button it says “register a card by scan”, and underneath that, in the second button, “request a registration code.” The registration code may be used to register the card to the application, or to login into the application the first time.

In yet alternate embodiments, to register a given card to the application, the magnetic strip or embedded chip on the credit card may be read, for example, using a card reader device connected to a computer or other user device, or via a RFID reader, and the card registered in this manner. It may be done, for example, by entering the linkage code in a special website (e.g., run by Application Server 1A20 in FIG. 1) that may be provided in various exemplary embodiments.

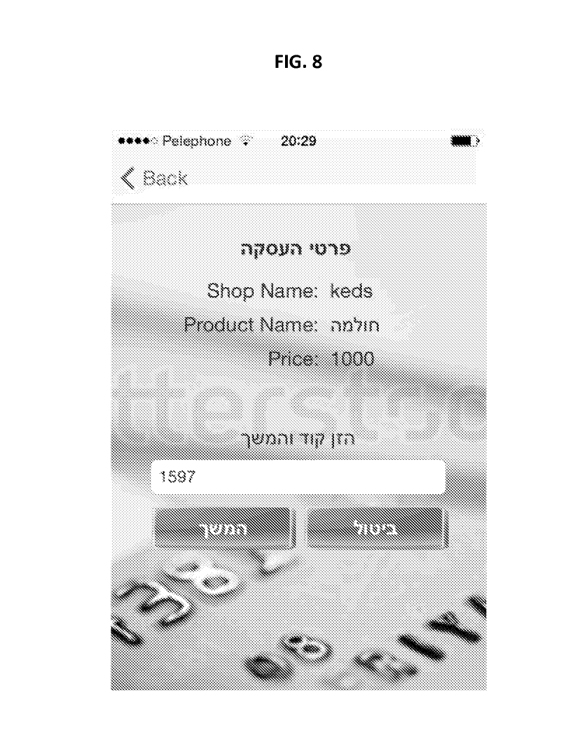

After linking a card, any card transactions it is submitted as payment for, that meet certain user defined criteria, for example, for charges in amounts greater than a set amount (see below re: filters), can be transferred to the cardholder application for approval in real time by the card holder, or if the card is an additional cardholder's, or the like, by either the actual cardholder, or the ultimate responsible party, such as a parent, or spouse, or the like. To confirm a transaction, the cardholder may enter an application secret code, as shown in FIG. 8.

Once a card has been registered via an exemplary application to the system, whenever that card—or any associated card to that card's account, such as an additional cardholder on the same account—is used to make a purchase, a cardholder approval process may be implemented as described below. In some embodiments the application may be subscribed to by various merchants, to apply to any charge made in their establishment. In others, the functionality may be used by a card issuer, in which case it may be provided for *any* purchase made on a given card, such as, for example, where a card issuer (e.g., a bank) utilizes the service as part of, or in place of, its fraud prevention protocols.

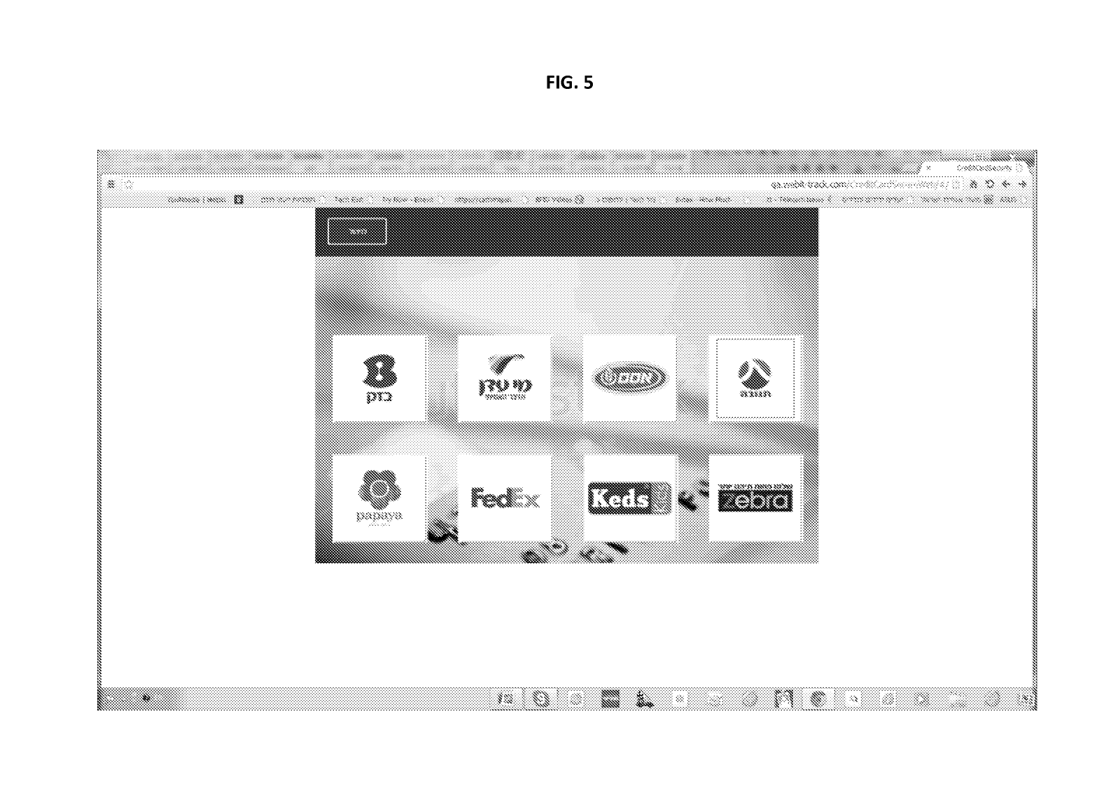

In an alternate embodiment, FIG. 5 illustrates an exemplary purchase screen, showing various registered stores, according to an exemplary embodiment of the present invention. Here a purchase using a registered card in any of these stores would be vetted, but not any use of the card, according to exemplary embodiments of the present invention. It is noted that if a given store or other merchant offers or uses the card verification service, process flow will be different than that depicted in FIGS. 1A and 1B, which illustrate the present transaction verification functionality integrated with that of the card issuer (e.g., a bank). In the exemplary case of FIG. 5, messages to the card issuer and to the application server would be sent in parallel, inasmuch as the card issuer may not be offering this service on its cards, only the merchant is offering it as to purchases in its store or stores, such as for example Macy's, Subway, Netflix, Amazon, or the like, for example.

This alternate exemplary system is shown, for example, in FIG. 1C, which is a modified version of the system depicted in FIG. 1A. In this case the merchant POS device, or other payment system module, would independently message both Card Issuer 1C10 and Application Server 1C20 and only finalize the transaction when *both* Card Issuer 1C10 and Application Server 1C20 send back an “approved” response message, it being understood that each of them runs it own approval/verification/fraud prevention routines independently, not even knowing that the other is involved. As noted above for the card issuer case, in some embodiments a merchant may desire to integrate the processing according to the present invention within its own POS processing, and thereby avoid having to message both the card issuer and the application server. In that case the merchant's system would include the functionality of Application Server 1C20, and send the verification request directly to the card holder, and receive back from such card holder the approval. There would be no Request C and Response C, in such an exemplary implementation. In fact, because two entities must be messaged in parallel in the system of FIG. 1C, it can often be more desirable, if possible, to do the card transaction verification processing according to the present invention on the merchant side, as opposed to sending to the application server, and then waiting while it contacts the user, and returns an approval message to the merchant.

To implement this functionality, for example, an API may be developed to create a link between a the merchant and the card user. Then, the merchant payment system can use this API to confirm that the charge is approved by the cardholder.

FIG. 6 is an exemplary card registration screen within a smartphone application according to an exemplary embodiment of the present invention, and FIG. 7 an exemplary purchase approval request screen on a merchant's side, here for an exemplary 1000 shekel purchase at a “Ked's Kids” store. In this example of FIG. 7, a sales clerk enters the information. In other exemplary embodiments, the system may do so automatically once the card is swiped or otherwise read, and an approval request is sent to the Card Issuer, to the Application Server, and/or to a Card Holder, as the case may be, and depending upon where software implementing the present invention is integrated, as discussed above. In some embodiments the information that the card is registered to an exemplary application according to the present invention may be stored within the card's magnetic strip, or integrated chip, for example.

FIG. 8 illustrates an exemplary cardholder purchase approval screen, as may be seen on a smartphone user device, where the cardholder is prompted to enter the secret code, according to an exemplary embodiment of the present invention. It is noted that in exemplary embodiments, there may be a “black list” and a “white list” for each credit card or payment card. If that merchant, at a given amount, is on the “white list” then the customer or card holder approves of the transaction without even having to specifically approve on the application. However, if a given transaction is not on the list then the card holder must approve. An exemplary “black list” and “white list” may be implemented as follows:

| Black List | White List |
|---|---|
| Geographic Data: State, City | Geographic Data: State, City |
| SUM: Above XXXX | SUM: Below XXXX |
| Category list: | Category list: |
| Company name | Company name |

It is noted that a transaction amount in a Black/White list (or in a filter as described below) may be specified in any currency. An exemplary application and system would convert it to other currencies if the card was used in, or via a merchant in, a foreign country. This may be done by means of a daily updated look up table, or by using the various currency converters that card issuers use.

Moreover, this concept maybe extended to multiple variables, in a filtering functionality, where whether a given transaction requires actual cardholder approval may be a function of one or more of, for example: date, geographic location, amount of the transaction, merchant name, merchant category, merchant location, transaction amount, transaction frequency, zip code, store name, store category, store number, transaction description, purchase frequency, total spending amount, and the like. Geographic filtering may also include an interface in which a user may draw a line around an area that is approved, or not approved, for example, by superimposing a line drawing on a Google maps screen, for example. This may be useful, for example, when visiting a city whose city center abuts a more dangerous neighborhood, or one where the tourist would simply not go, and thus if a charge comes through within the area enclosed by the lines, it is tagged, and submitted for approval. In exemplary embodiments, for example, a user can set the filters by types or categories of stores. For example, all “gas stations” may be subject to approval, without which the card will not work in any gas station. In some embodiments a user can set other types of geo-location based filters. In some embodiments a user may set transaction ceiling amount filters, such as, for example, no more than $1,000.00 in charges per day, without approval. Various filtering variables may be combined, or may be set to a priority or preference of application, in various exemplary embodiments.

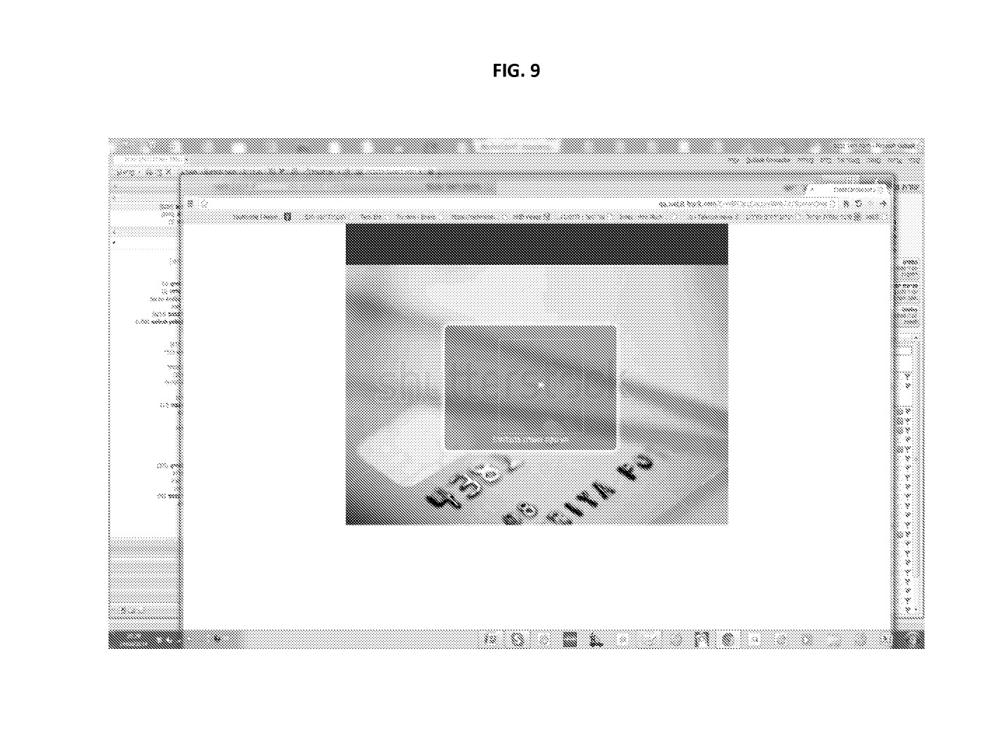

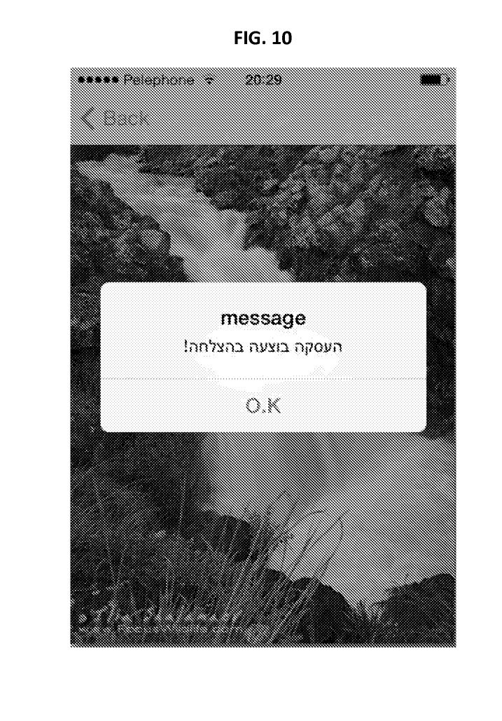

FIG. 9 illustrates how once the cardholder has approved the purchase via his smart phone, the merchant receives a credit authorization via a Credit Console (assuming the transaction is otherwise approved according to the terms of the credit card issuer), and FIG. 10 illustrates an exemplary indication of approval of the transaction screen shown to the cardholder within the smartphone application.

### Password Security

A card holder would remember his or her password and “secret code” like other passwords. On the system end it will be stored. However it is noted that even if a fraudster knows the secret code, without their also knowing which card is being processed, a fraudulent transaction could not occur. Thus, in exemplary embodiments, in exemplary systems only the password will be stored but not any credit card numbers. Thus, a fraudster would need the card itself to be able to really make a transaction. And that's why the card number isn't on the system at all. Because this is sent to our system even if a hacker could steal the credit card numbers they would never know which app and password would approve the specific card.

In some embodiments there may be one “secret code” per user, for all registered cards or stores, in others there may be a separate code per issuing bank, etc. There is a limit as to how many secret codes may be remembered by a user, so the fewer the better, in most cases.

### Welfare/Food Stamps/Government Program Fraud Prevention

In exemplary embodiments of the present invention, in addition to, or in place of, the cardholder purchase approval functionality described above, a check on legitimate purchases functionality may be similarly implemented. As is known, most government programs now distribute payment cards to enrollees of the program, such as food stamps, welfare, etc. This is often also used by private charities to provide food and other basic necessities monies to their clients. The payment cards are used at a store in the same manner as regular credit or debit cards. However, the store is often tasked with making sure that only allowed items to be purchased with the card are what is being purchased. This is often loosely policed, or not controlled at all.

In exemplary embodiments of the present invention, the filtering layer may be used to automatically decline any transaction that includes a forbidden item under the program. These are commonly “vice” items, such as liquor, tobacco, etc., but can be set to be anything. The POS device may be configured (and this is generally the case) to store the list of items purchased, inasmuch as they were all scanned into the payment system via bar code, and are thus “known” to the store's payment system at the time of sale.

Any item would be flagged, and the purchase denied. In this context the “cardholder” is actually the government or charitable agency issuing the payment card. By collecting data from all such denied transactions, it can be easily known which stores have the most attempts, and thus may not be enforcing the program rules as they should.

In exemplary embodiments of the present invention, a similar use may be implemented for medical insurance programs where the insured carries a debit card. Only certain drugs and procedures are covered, and it is against plan rules to access these funds for disqualified services or goods. By immediately cross-checking what items the cardholder is allowed to use the debit card for, fraud and misuse may be significantly curtailed. The market for this service is immense, inasmuch as certain major insurance payers, including the VA, rely heavily on the use of credit cards to reimburse health care providers for services rendered.

### Embedded Advertising in Approval Application

In exemplary embodiments of the present invention, application screens may be displayed matching engine advertising according to location and type of previous acquisitions. Because a system according to the present invention alone has the possibility of registering *every* card that a user utilizes (assuming most card issuer's utilize the service), much better and detailed data on purchases and purchase patterns is available. An exemplary system “knows” your customer better than any single card issuer he does business with.

Some “advertising” may be different than is commonly expected. In exemplary embodiments according to the present invention, because a system is operable with every credit card, payment card etc., it can easily track and store details of promotions, interest rates, points awards, foreign currency transaction fees, and the like, for the various credit cards, or other payment cards, whose transactions are vetted by the system. Thus, the system is uniquely able to match a user's purchasing profile with various other cards and any specific benefits that the user may reap, were he or she to have used the alternate card. That makes messaging within the application a unique platform in which to advertise new cards, make promotional offers, or inform potential users of pre-approval status.

### Capacity Planning

In exemplary embodiments of the present invention, it is important to anticipate peak usage and resource utilization pattern. If implemented in straightforward manner, an exemplary payment authorization agent will need to maintain transaction states for the entire lifetime of a transaction. In cases where manual approval is required, such lifetime may exceed a hundred seconds unless an artificial cap is provided. Most existing transactional software has been oriented towards reduction in transaction time—in fact, in the algorithmic trading industry the trend has been to move as much logic as possible into silicon and to reduce transactional round-trip to sub-microsecond time. In our case, when in production and providing service to one or more of the global payment networks or issuers, a throughput of over 100,000 transactions per second maintaining full transaction state throughout its lifetime and processing them accordingly will present unique challenges to the platform, logic and network alike. As such, as mentioned above, it is definitely preferable—and some would say necessary—to have an active/active schema for all components, whereby each transaction is propagated through the system and no outage can bring the system down. It is a matter of partitioning and resources whether a single outage or even a systemic outage can have impact on transactions in the pipeline (for example, they may need to be rejected or rolled back for a resubmission).

From the outward facing load balancers to transaction monitors and application servers to the database, the infrastructure should be designed taking into account the fact that hardware—especially storage—is cheap almost to the point of being negligible, while time and risk of data corruption and loss and expensive to the point of being irreplaceable. Redundancy on components level and on data level will decrease overall density of entropy and can make the system extremely resilient—in a way analogous to the central nervous system of mammals, such as human brain.

Injection of the new authorization step should be done in the way that is least intrusive to the established ways of conducting transactional business. Yet, it is worth noting that the kind of protocols and infrastructure that will be rolled out to support the new authorization model, can also be utilized and augmented to provide a full spectrum of electronic payment solutions if business goals align with the industry and consumer

### GPS:

In exemplary embodiments of the present invention, the physical location of a user's smartphone may be leveraged in the approval process. For example, in some embodiments, an important feature may utilize pinging a client application on a cardholder's smartphone to obtain their GPS location, to be verified against proximity to the terminal and smart-chip readers. Cardholders can set parameters as to when to apply or require such GPS verification. In some embodiments, the user need not manually approve certain transactions as long as it is clear that the smartphone is actually in the physical location of the merchant generating the charge. All that is needed is an exemplary System Server to acquire the GPs information regarding the user device at the time, thus speeding up the process.

### Summary of Exemplary Security System for Credit Card Transactions

Given the discussion thus far, the following is a short summary of an exemplary Security System used for credit card transaction approval according to exemplary embodiments of the present invention.

### General Process

There are two main parts to an exemplary card security system according to exemplary embodiments of the present invention, Client Device, and Server Processes.

### 1. Client Device

A user adds his/her personal information and credit card(s) information to the Security System.
A user adds filters on card transactions and applies certain rules on how to handle transactions that meet those filters.
A user either approves or decline transactions that need his/her explicit approval.

### 2. Server Processes

Server receives a card transaction approval request.
Server checks whether the relevant card has been added to the Security System.
If card is not in the Security System, Server responds with a “Not Applicable” message.
If card is present in the Security System and the conditions of the transaction have a rule that approves such transaction, Server responds with an “Approved” message.
If card is present in the Security System and the conditions of the transaction have a rule that declines such transaction, Server responds with a “Declined” message.
If card is present in the Security System and the conditions of the transaction have a rule that requires specific approval (or user's device information) for such transaction, Server will notify the user and wait for the user's response (or the data from the user's device). Server responds with the users response (or rule.

### Detail of Client Side Processes

The client will add his/her personal information and credit card(s) information through a client portal which can be any of:

A desktop web application accessed via a web browser;

A desktop application built for the used operating system;

A smartphone web application accessed via a web browser; or

A smartphone application built for the used smartphone operating system.

Once a card is added to the Security System the user can either set their own filters, rules and settings or use any of a set of default filters, rules and settings implemented by the Security System.

### Exemplary Rules and Settings

Rules and settings include different actions the Security System should apply to transactions made with card(s) added to the Security System that meet specific filters.

The following are a non-limiting list of exemplary filtering rules:
A user can add a specific Merchant to a black list to always decline transactions coming through said Merchant.
A user can add a specific Merchant to a white list to always approve transactions coming through said Merchant.
A user can add a specific Merchant to a check list to always need explicit approval for transactions coming through said Merchant.
A user can add an area/location to a black list to always decline transactions coming through said area/location.
A user can add an area/location to a white list to always approve transactions coming through said area/location.
A user can add an area/location to a check list to always need explicit approval for transactions coming through said area/location.
A user can add a time or time period to a black list to always decline transactions coming through said time/time period.
A user can add a time or time period to a white list to always approve transactions coming through said time/time period.
A user can add a time or time period to a check list to always need explicit approval for transactions coming through said time/time period.
A user can add a dollar amount to a black list to always decline transactions that equals or is greater than said dollar amount.
A user can add a dollar amount to a black list to always approve transactions that equals or is greater than said dollar amount.
A user can add a dollar amount to a check list to always need explicit approval for transactions that equals or is greater than said dollar amount.
A user can add a dollar amount to a black list to always decline transactions that equals or is less than said dollar amount.
A user can add a dollar amount to a black list to always approve transactions that equals or is less than said dollar amount.
A user can add a dollar amount to a check list to always need explicit approval for transactions that equals or is less than said dollar amount.
A user can add a rule that is comprised of a combination of rules including one or more of the following rules: a specific Merchant, a specific area/location, a specific time/time period, a dollar amount ceiling or a dollar amount floor to a black list to always decline transactions that satisfy the combined rule.
A user can add a rule that is comprised of a combination of rules including one or more of the following rules: a specific Merchant, a specific area/location, a specific time/time period, a dollar amount ceiling or a dollar amount floor to a white list to always approve transactions that satisfy the combined rule.
A user can add a rule that is comprised of a combination of rules including one or more of the following rules: a specific Merchant, a specific area/location, a specific time/time period, a dollar amount ceiling or a dollar amount floor to a check list to always need explicit approval for transactions that satisfy the combined rule.
A user can add a rule to always decline a transaction that meets any two or more rules out of a group of three or more rules including any combination of the following rules: a specific Merchant, a specific area/location, a specific time/time period, a dollar amount ceiling or a dollar amount floor.
A user can add a rule to always approve a transaction that meets any two or more rules out of a group of three or more rules including any combination of the following rules: a specific Merchant, a specific area/location, a specific time/time period, a dollar amount ceiling or a dollar amount floor.
A user can add a rule to always require explicit approval for a transaction that meets any two or more rules out of a group of three or more rules including any combination of the following rules: a specific Merchant, a specific area/location, a specific time/time period, a dollar amount ceiling or a dollar amount floor.
A user can adjust, edit and delete any filter or group of filters.
A user can adjust any filter or group of filters to apply stated rule only at specific days, time and time periods.
A user can add a fallback rule to approve any transaction that meets a filter or group of filters that require explicit approval in case he/she fails to respond.
A user can add a fallback rule to decline any transaction that meet a filter or group of filters that require explicit approval in case he/she fails to respond.

When a user receives a manual approval request the user will need to respond by either approving or declining the transaction. If there is no response from the user the Server will respond with the fallback rule.

Alternatively, a user can optionally will have an option to have the system remember his/her response and always respond with the same.

The response request, in some embodiments, may be delivered to the user via the app on his or her smartphone. However, in some embodiments it may be delivered in parallel through multiple pathways, including email, SMS, social media messaging, autodial to landlines, and of course via messaging within the app. If the user does not respond within a given time, time out rules can be applied, or, for example, a second timer can start, and additional round of “URGENT” messaging to the user may be sent, after which the time out rules can be applied. Various rounds of messaging and various messaging pathways are contemplated, all being within the scope of the invention.

### Detail of Server Side Processes

In general, a transaction request can be sent to the Security System by any participating party. This can be any entity that handles the transaction during the transaction approval cycle. The exact details on how the participating entity will communicate with the Security System are discussed in great detail below. This section discusses the process that the Security System will go through once it receives a transaction for an approval request.

The job of the server side processes is to determine if the charge on the card is a legitimate one. There will be a set number of response codes that the server can respond with. Each response code can, for example, represent a different response message. For example, the responses can be one of the following:
Not Applicable (card in question is not in the system).
Checking (As per card settings this transaction needs explicit approval from card holder).
Approved (As per card settings or per by explicit approval this transaction is authorized by card holder).
Declined (As per card settings or per by explicit declination, this transaction is not authorized by card holder).

When the server receives a request to verify a transaction, the Server will first check if the card in question has been added to the Security System. If the card in question was never added to the Security System, the server will respond with a “Not Applicable” or similar message.

If the card in question was indeed added to the Security System, the server will check the settings what rule to apply for this particular transaction. If the rule in the System for this type of transaction is a clear Yes or No answer, the Server will respond accordingly, “Approved” or similar for yes and “Declined” or similar for a no. For example if a transaction request comes through with a Merchant that has been added to a black list by the user, the Server will promptly respond with a “Declined” message.

If the conditions in the transaction request in question have a rule that requires explicit approval from the user, the Server will respond with a “Checking” message.

When the System responds with a “Checking” response, the communication with the participating party will not be terminated by the Server. Instead the Server will wait for a response from the User.

If the Server fails to get a response from the User, there will be a set timeout at which point the Server will respond to the participating party with the fallback rule that applies in that particular situation.

When the server sends a message to the User, the Server will do so through all client connected devices.

The User will have the option to either accept or decline the transaction.

When the Server gets the response back from the User, the Server will promptly respond to the participating entity with the appropriate response.

The whole process of the Server determining the response as well as initiating the response will be a super-fast process as discussed in greater detail below, regarding performance.

Exemplary Messaging and Use Scenarios

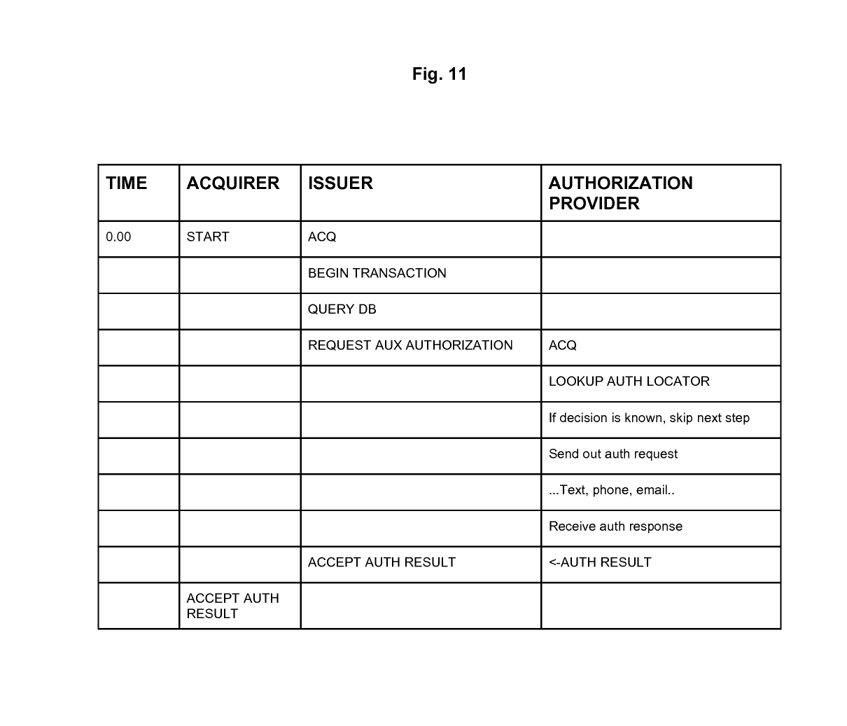

In what follows, an exemplary messaging flow, and four exemplary use scenarios are described, with reference to FIGS. 11-15. The scenarios vary as to the type/amount of purchase for which approval is sought, what rules are triggered by the transaction, and the decision making in response to that request and those rules performed at an exemplary application server. Following the four scenarios, exemplary messaging formats for both originating messages and messages from application server to cardholder device, are presented. For purposes of this next description, the exemplary application server will be referred to as the “NartiQ” sever, which is a trademark the Applicant hereof contemplates using for various exemplary embodiments of the present invention.

FIG. 11 illustrates exemplary messaging between each of an Acquirer, a Card Issuer and an Authorization Provider according to exemplary embodiments of the present invention. As can be seen from FIG. 11, an Acquirer, such as a POS device in a store, swipes or otherwise reads (e.g., via chip reader, near field communication reader, or the like) information from a user's credit card. The Acquirer sends a message over a network to a Card Issuer, which can include Issuing Banks, or, more commonly, an exchange such as Visa or Mastercard, for example. The Issuer initiates an approval transaction by querying an internal database. The information indicates that the card holder is a NartiQ subscriber, and therefore an auxiliary authorization from NartiQ's

### Exemplary Algorithm and Flow:

### Definitions

Transaction is an object containing all data and information pertaining to a transaction being handled
Message is a string of character that contains all data that is transmitted from the card terminal via one of the card network
DecisionEngine is an object containing a list of rules and methods necessary for approval or decline of a transaction
Decision is one of either APPROVE, DECLINE or MANUAL states
Merchant is an object representing the entity that originates a transaction
Receiver is an object representing the bus entity that receives and processes a transaction—ending with the issuing bank
Parser is an object that contains definitions, rules and methods necessary for translating a raw Message into a Transaction based on ISO 8583
ApprovalEngine is an entity that is capable of communicating directly with the decision maker (usually the account owner) via SMS, Internet, Phone or otherwise.
Listener is an object that receives messages
Sender is an object that originates messages

The following is exemplary pseudocode illustrating messaging between relevant parties to an approval transaction according to exemplary embodiments of the present invention:

```
Message := Receiver.Listener.Receive( );
Transaction := Parser.Parse(Message);
/*
  Now each relevant field in Transaction is populated in accordance with
ISO standard
*/
Decision := DecisionEngine.ApplySetOfRules(Transaction);
if Decision == MANUAL
then
  ApprovalEngine.SubmitManualApproval(Transaction);
  // Wait for no longer than specific timeout
  Decision := ApprovalEngine.ReceiveManualApproval(Transaction);
end if;
case Decision of
when  DECLINE
then
      Status := “Transaction declined. Please contact issuing bank for
      details”;
      Abort;
when  APPROVE
then
      Status := “Transaction approved.”;
      Receiver.ProceedWithTransaction(Transaction);
end if;
when  default
then
      Status := “Transaction denied due to system error. Please try again
later or contact issuing bank for details”;
      Abort;
end case;
finally :
      Sender.Send(Merchant, Status);
```

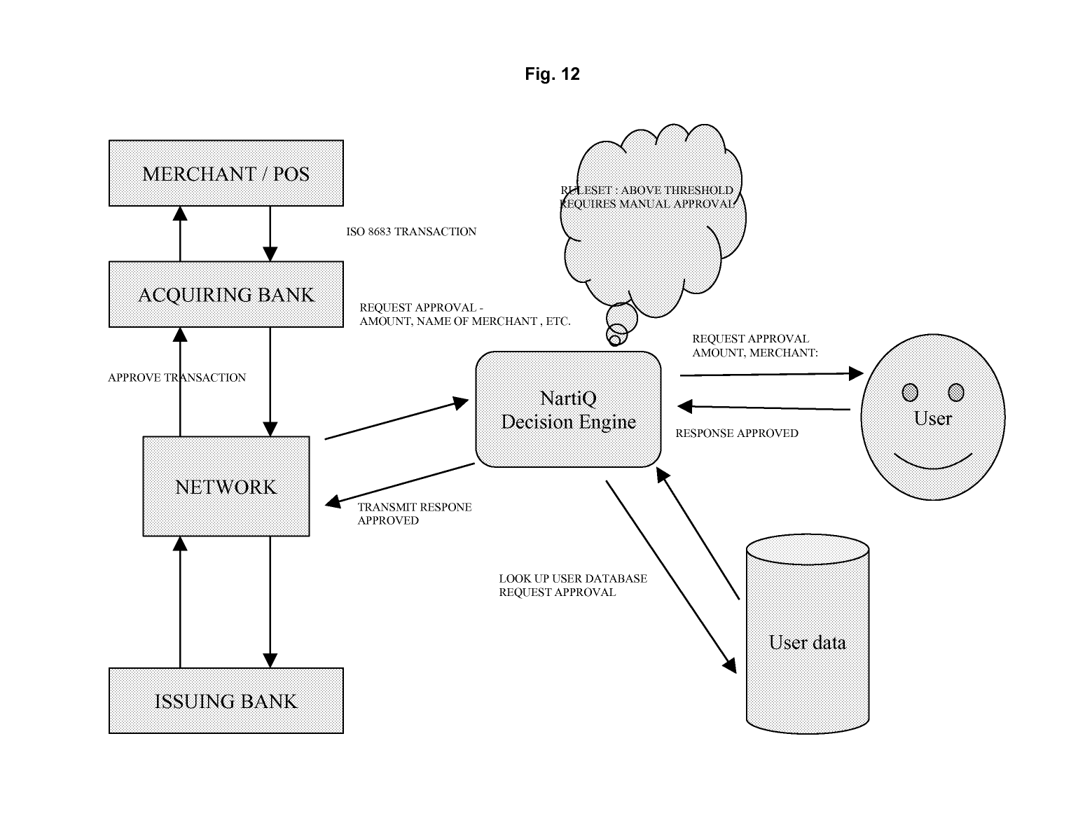

In FIGS. 12-15 the exemplary application server is shown as containing a “Decision Engine.” The Decision Engine contains a series of rules, sequential application of which makes a decision that can be applied in the normal approval flow prior to resorting to manual approval. Furthermore, the Decision Engine can augment manual approval with additional rules. For example, as noted above, if geographic proximity of the transaction origin (terminal) is immediate to the coordinates of the user, it may decide to approve the transaction without waiting for manual approval from the user. As such, the settings for the decision engine are a part of overall card/account information that is stored in a card issuer's database. Access to issuers' data is optional. In some embodiments it can, for example, enhance both the range of services offered, their reliability and their performance.

FIG. 12 illustrates a common basic scenario. A cardholder swipes his credit card at a Merchant terminal for the amount of $250.00. The Merchant's terminal/POS sends the transaction request along with all information necessary for a typical card transaction to the Acquiring bank which in turn sends it through the Network/Association to the Issuing bank for approval. Along the way one the four aforementioned entities sends the transaction request to the NartiQ Security System for cardholder approval, as described above, in various alternate embodiments. When the NartiQ Security System receives the transaction it first queries its user data engine for cardholder settings pertaining to particular card involved in the transaction. It sees that the cardholder has a rule saying that any transaction with amount greater than $200.00 needs manual approval. The NartiQ server system pushes a notification to all reachable cardholder client devices asking for approval. The cardholder approves the transaction, and the NartiQ system transmits the approval response to the initiating entity.

This FIG. 12 scenario is summarized in the following messaging exchange:

| | |
|---|---|
| 1. | Merchant to the Acquiring Bank to the Network - ISO 8583 |
| | TYPE=200 AMT=250.00 DATE=NOV 9 20:35 TRACE=000666 |
| | TIME=2030100 DATE-ISSUED=1109 LIMIT- DATE=1109 |
| | EXPIRATION-DATE=1802 CVV=456 CARD- |
| | DATA=4728227733239808 CURRENCY=USD ETC. |
| 2. | Network to NartiQ - Requesting(250.00, MerchantInfo, |
| | CARD-DATA, DATE) |
| 3. | NartiQ queries UserData - Lookup contact information and approval |
| | rule-sets for CARD-DATA |
| 4. | UserData to NartiQ - Contact info is SMS 212-555-2292, GCM ID |
| | ACX45309VXC RULE-SET {above 200: manual approval} |
| 5. | NartiQ to User either via App, WebApp, SMS: Approve/Decline |
| | 250.00 from MERCHANT xyz |
| 6. | User to NartiQ : Affirmative |
| 7. | NartiQ to Network : Request Approved |
| 8. | Network proceeds to Acquiring Bank as per ISO-8583 |

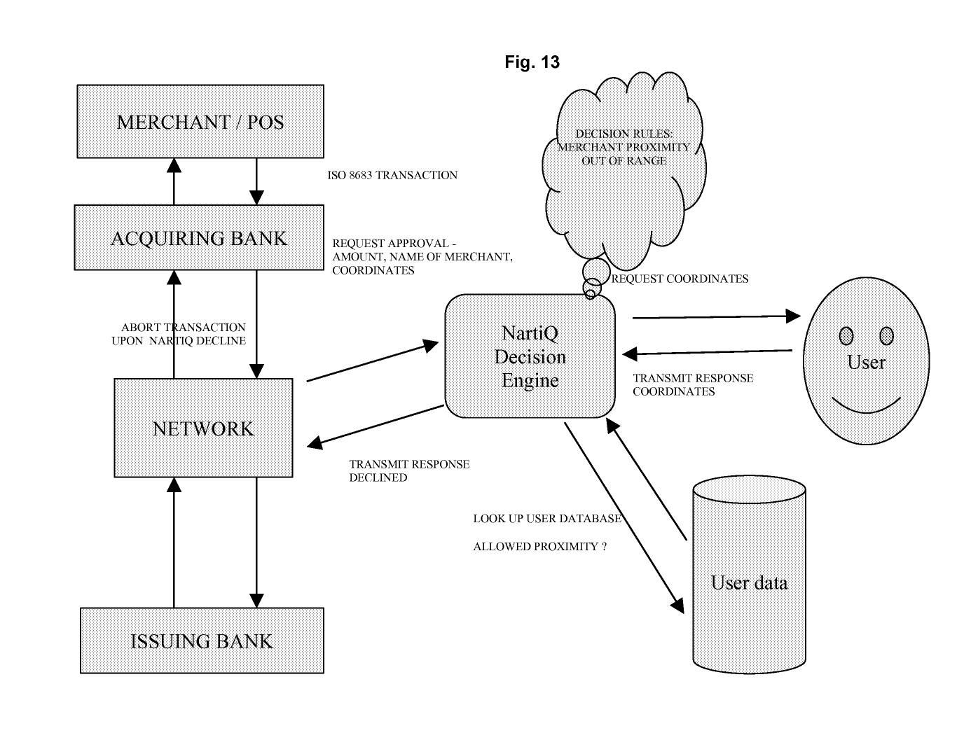

FIG. 13 illustrates an exemplary approval decision by the NartiQ server based on GPS co-ordinates of the cardholder. A cardholder swipes his credit card at a Merchant terminal for the amount of $250.00. The Merchant's terminal/POS sends the transaction request along with all information necessary for a typical card transaction to the Acquiring bank which in turn sends it through the Network/Association to the Issuing bank for approval. Along the way one the four aforementioned entities sends the transaction request to the NartiQ Security System for cardholder approval, as described above, in various alternate embodiments. When the NartiQ Security System receives the transaction it first queries its user data engine for cardholder settings pertaining to particular card involved in the transaction. It sees that the cardholder has set a rule saying that any transaction involving the physical card needs to check cardholder coordinates to match against proximity to terminal/chip-reader, etc. The system pushes a notification to a registered cardholder handheld device asking for GPS coordinates. The cardholder handheld device responds with GPS coordinates, but there is no need for the user to manually approve. The system matches coordinates against Merchant proximity and sees that they do not match. The System transmits a “declined” response to the initiating entity.

This FIG. 13 scenario is summarized in the following messaging exchange:

| | |
|---|---|
| 1. | Merchant to the Acquiring Bank to the Network - ISO 8583 |
| | TYPE=200 AMT=250.00 DATE=NOV 9 20:35 TRACE=000666 |
| | TIME=2030100 DATE-ISSUED=1109 LIMIT-DATE=1109 |
| | EXPIRATION-DATE=1802 CVV=456 CARD- |
| | DATA=4728227733239808 CURRENCY=USD ETC. |
| 2. | Network to NartiQ - Requesting(250.00, MerchantInfo, |
| | CARD-DATA, DATE) |
| 3. | NartiQ queries UserData - Lookup contact information and approval |
| | rule-sets for CARD-DATA |
| 4. | UserData to NartiQ - Contact info is SMS 212-555-2292, GCM ID |
| | ACX45309VXC RULE-SET {Terminal transactions: check |
| | cardholder coordinates} |
| 5. | NartiQ to User either via App: whats your coordinates |
| 6. | User to NartiQ : {latitude: 40.7127837, longitude: |
| | −74.00594130000002} |
| 7. | NArtiQ Decision Engine: Matches cardholder coordinates to |
| | Merchant proximity |
| 8. | NartiQ to Network: Request Declined |
| 9. | Network proceeds to Acquiring Bank transaction DECLINED. |

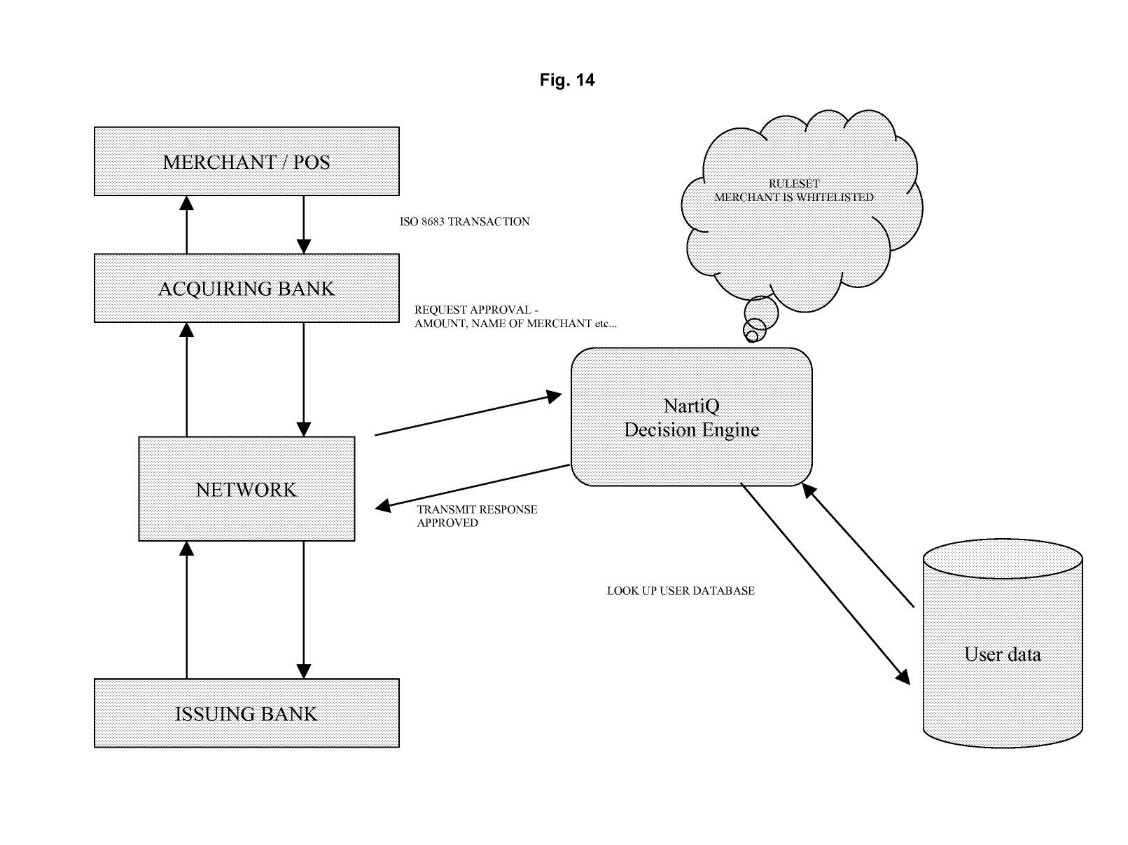

FIG. 14 illustrates an exemplary automatic approval decision based on filtering, in particular a “whitelist.” A cardholder swipes his credit card at a Merchant terminal for the amount of $250.00. The Merchant's terminal/POS sends the transaction request along with all information necessary for a typical card transaction to the Acquiring bank which in turn sends it through the Network/Association to the Issuing bank for approval. Along the way one the four aforementioned entities sends the transaction request to the NartiQ Security System for cardholder approval, as described above, in various alternate embodiments. When the NartiQ Security System receives the transaction it first queries its user data engine for cardholder settings pertaining to particular card involved in the transaction. It sees that the cardholder has a rule saying that any transaction made through this Merchant needs no further confirmation. The system will transmit approval response to the initiating entity.

This FIG. 14 scenario is summarized in the following messaging exchange:

| | |
|---|---|
| 1. | Merchant to the Acquiring Bank to the Network - ISO 8583 |
| | TYPE=200 AMT=250.00 DATE=NOV 9 20:35 TRACE=000666 |
| | TIME=2030100 DATE-ISSUED=1109 LIMIT-DATE=1109 |
| | EXPIRATION-DATE=1802 CVV=456 CARD- |
| | DATA=4728227733239808 CURRENCY=USD ETC. |
| 2. | Network to NartiQ - Requesting(250.00, MerchantInfo, |
| | CARD-DATA, DATE) |
| 3. | NartiQ queries UserData - Lookup contact information and approval |
| | rule-sets for CARD-DATA |
| 4. | UserData to NartiQ - Contact info is SMS 212-555-2292, GCM |
| | ID ACX45309VXC RULE-SET {merchant xyz: approved} |
| 5. | NartiQ to Network : Request Approved |
| 6. | Network proceeds to Acquiring Bank as per ISO-8583 |

Another scenario based on hot-approval.

### A Cardholder Sends

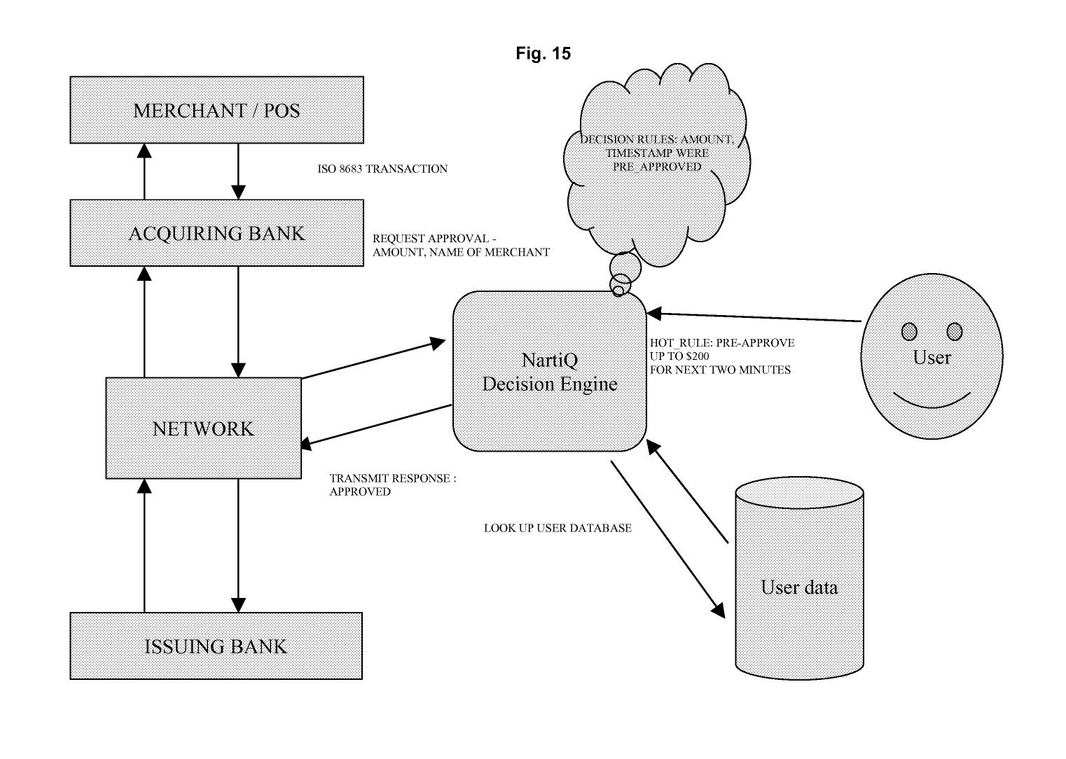

FIG. 15 illustrates an exemplary automatic approval decision based on filtering, in particular a HOT-RULE. A Hot-Rule is one a user sets up to clear transactions that would otherwise need approval. For example, a hot-rule may say “for the next half hour any transaction under 500 dollars is approved.” A cardholder swipes his credit card at a Merchant terminal for the amount of $250.00. The Merchant's terminal/POS sends the transaction request along with all information necessary for a typical card transaction to the Acquiring bank which in turn sends it through the Network/Association to the Issuing bank for approval. Along the way one the four aforementioned entities sends the transaction request to the NartiQ Security System for cardholder approval, as described above, in various alternate embodiments. When the NartiQ Security System receives the transaction it first queries its user data engine for cardholder settings pertaining to particular card involved in the transaction. It sees that the cardholder has set a Hot-Rule pre-approving any transactions less than $500 and within a defined time period of when the rule was set. System transmits an Approved response to the initiating entity.

This FIG. 15 scenario is summarized in the following messaging exchange:

| | |
|---|---|
| 1. | Cardholder to NartiQ {action: approve, amount: < 500, |
| | time: <= 1447185600} |
| 2. | Merchant to the Acquiring Bank to the Network - ISO 8583 |
| | TYPE=200 AMT=250.00 DATE=NOV 9 20:35 TRACE=000666 |
| | TIME=2030100 DATE-ISSUED=1109 LIMIT-DATE=1109 |
| | EXPIRATION-DATE=1802 CVV=456 CARD- |
| | DATA=4728227733239808 CURRENCY=USD ETC. |
| 3. | Network to NartiQ - Requesting(250.00, MerchantInfo, |
| | CARD-DATA, DATE) |
| 4. | NartiQ queries UserData - Lookup contact information and approval |
| | rule-sets for CARD-DATA |
| 5. | UserData to NartiQ - Contact info is SMS 212-555-2292, GCM |
| | ID ACX45309VXC RULE-SET {pre-approve: {amount: <500, |
| | time: <= 1447185600}} |
| 6. | NartiQ to Network: Request Approved |
| 7. | Network proceeds to Acquiring Bank transaction DECLINED. |

### Sample Messaging Formats

Two exemplary sample messages are next provided.

### Sample Originating ISO 8583 Message:

```
Raw String :
723c57c16fe08801169000000000000001000000000000310000110904203
347359304203311091611173184000000100300010644411137123456789
0123456=12345678901234567890123456789ABC12345600ABC1000000
2123456789012345Merchant 123 Main St  Brooklyn  NY
0012345678901234560000
When parsed into a JSON data structure:
{
  “primaryAccountNumber”: “169000000000000001”,
  “ProcessingCode”: “000000”,
  “amount”: “000000310000”,
  “transmissiondateTime”: “1109042033”,
  “systemTraceAuditNumber”: “473593”,
  “transactionLocalTime”: “042033”,
  “transactionLocalDate”: “1109”,
  “cardExpirationDate”: “1611”,
  “merchantType”: “1731”,
  “PANextendedCountryCode”: “840”,
  “pointOfServiceEntryMode”: “000”,
  “PANsequenceNumber”: “001”,
  “functionCode”: “003”,
  “pointOfServiceConditionCode”: “00”,
  “pointOfServiceCaptureCode”: “01”,
  “acquiringInstitutionIdCode”: “06444111”,
  “PANextended”: “”,
  “track2data”: “371234567890123456=12345678901234567890”,
  “retrievalReferenceNumber”: “123456789ABC”,
  “authorizationIdentificationResponse”: “123456”,
  “responseCode”: “00”,
  “serviceRestrictionCode”: “ABC”,
  “cardAcceptorTerminalId”: “10000002”,
  “cardAcceptorIdCode”: “123456789012345”,
  “cardAcceptorNameLocation”: “Merchant 123 Main St  Brooklyn
NY”,
  “currencyCode”: “”,
  “securityrelatedControlInformation”: “001234567890123456”,
  “messageAuthenticationCode”: “0000”
}
```

Sample Message from Application Server to Cardholder Device:

```
JSON data structure:
{
  “operation”: 01, (asking for confirmation)
  “amount”: 12300,
  “type”: 01, (swipe: 01, keyin: 02, e-commerce: 03, etc...)
  “cvv”: true, (true, false)
  “merchant”: {
    “name”: “ACME Merchandise”,
    “Address”: {
      “line1”: “125 Main Street”,
      “line2”: “Suite 202”,
      “line3”: “”,
      “city”: “Brooklyn”,
      “state”: “NY”,
      “zipcode”: “11219”,
    },
    “dba”: “WWW.ACHME.COM”,
    “terminalId”: “987098”,
    “idCode”: “WEM090878123456”,
  },
  “description”: “”,
  “additionalInformation”: “71949134 888-220-0146
WWW.ACHME.COM”,
  “Reference”: “320153090337199021”,
  “category”: “Merchandise & Supplies”,
}
```

### Exemplary Implementation and Exemplary Systems

Charge Cards (including debit and credit cards, henceforth “CC”) are widely used by businesses and consumers. They utilize relatively few proprietary global branded networks for transaction exchange—MasterCard, VISA, American Express (“AMEX”) and Discover represent the bulk of the industry. CCs are also issued by businesses (such as department stores) and have limited recognition outside of issuer's network.

Business conducted via CCs is vertically divided between the acquirer (entity close to the merchant) and the issuer—often a bank or a financial institution. In the case of AMEX, both functions are combined: each function is performed by different business units of the same company. The function of the acquirer is to service merchants' Point of Sale terminals (POS)—in short, to provide them with access to the relevant networks. The function of the issuer is to interface with cardholder and its bank and as such to ultimately act on the receiving end of a card transaction.

As noted above, conventional CC networks provide users with some rudimentary methods of authentication, such as PIN codes (ubiquitous in the ATM segment), CVV and address verification. Still, CC fraud is a thriving criminal enterprise and both merchants and issues lose billions every year due to such fraud. In order to implement systems according to exemplary embodiments of the present invention, capable of providing more sophisticated authorization services in real time, a number of concerns need to be addressed:
1. Heterogenous nature of the network—outside of the relatively standard methods of data interchange between merchant terminal and the issuer, it is expected that most participants use some proprietary format to shuttle data between nodes within their own network. Furthermore, data captured by the issuer is also probably stored in their own proprietary format. To mitigate this, proposed solution should be format-agnostic—able to consume and supply data in any format, as long as such format is described in a plugin fashion. XML is a good way to efficiently describe such data transformations and when done properly, they should not represent a major performance hurdle.
2. Performance and Scalability—ideally, the proposed system should be able to “scale up” and “scale out”—meaning that the same piece of software should run with minimal changes on a minimal developers′/QA desktop, on a smaller server and should continue with performance increase as close to linear as possible when more resources—bigger servers, more network bandwidth, more storage—is added to the system.
3. Reliability—in the post 9/11 world, businesses became more aware about acute need of disaster recovery and business continuity plans. The truth is that it is always wiser to design the system from the beginning to have no single points of failure and no obvious chokepoints. From simple software or hardware failures, to more subtle issues of data corruption to entire datacenter outages, a business that purports to provide additional security on transactional level should have 100% unscheduled uptime and 99.99% of scheduled uptime—allowing in theory for some scheduled maintenance for some elements of the system. Every node in such system should be able to sustain outage without substantially affecting overall performance. As is described below, careful design and implementation of the right combination of software and hardware from the beginning can provide such reliability.
4. Efficiency—in modern world, in order to remain profitable, a business needs to be conscious of its systems efficiency on all levels. That means that on one hand, it is important to take into account total cost of ownership when acquiring an asset or deciding on a technology choice. It also means that ceteris paribus, a business should avoid dependence on proprietary vendors and systems, and emphasis should be made on interoperability and compatibility with technologies that may become of interest at some future point. As modern business world has by much accepted Java as platform of choice, it would be wise to use Java in the implementation stack for a number of reasons—ability to run on a variety of platforms, availability of skillful developers, relatively high performance and scalability, and a wealth of high quality libraries and APIs that allow it to interface with just about everything.
5. Security—needless to say, a business that provides transactional security in the most sensitive civilian sector needs to focus on its own security from the very beginning. Design and implementation of the network topology, physical security, application security, encryption on every level, strict mandatory access controls, auditing, compliance with regulations, document management and retention, ERP/CRM—all the aspects of such business need to be secure by design. The cost of implementing a secure component are negligible compared to cost of replacing an unsecure component with a secure one. The cost of a potential breach or even a perception of a vulnerability are simply unacceptable for such a business model.

The following provide some analysis of execution layers and how they translate into readily available commercial and open source products.

On the physical layer, network interconnection should be done using industry standard 1 Gb and 10 Gb Ethernet (Cisco and HP carry all the necessary products). Remote datacenters can be connected via leased Ethernet lines readily available from Verizon or any other reputable data network.

Storage layer should be ideally implemented as a SAN—at least partially. Benefits of SAN are numerous, in particular it would abstract the complexity of managing the storage pool from the rest of the server farm.

Choice of platform: while it is true that the low end of the spectrum has been losing ground to the Intel/Linux combination, there is no evidence that it's a choice motivated by anything other than cost savings and lack of proper experience and knowledge. In implementing embodiments of the present invention, Oracle Solaris would be an ideal operating system for a number of reasons. First of all, it is available on a wide range of hardware from commodity Intel desktops and servers that could be used for development and testing—and all the way to high end Oracle servers that can provide more than 1000 CPU threads, thousands of gigabytes of RAM and petabytes of storage, as well as unsurpassed features in reliability and tunability (like an ability to hot-swap a live memory or CPU module). Moreover, Oracle produces several more technologies that would integrate well in a properly tuned environment—Oracle owns Java technology, and Java virtual machine due to its original and ongoing design performs particularly well on SPARC hardware. Oracle Database is one of the more obvious choices here for storage of transactional data, and combination of Solaris and Oracle database is a hallmark of reliability, stability and performance as far as Oracle is concerned.

Alternative choices exist: Intel Xeon running Linux or Solaris are a reasonably robust low-end solution. Intel Xeon running Solaris would provide many of the same benefits available on SPARC running Solaris, and is certainly cheaper to acquire on the lower end of the spectrum. In fact, a combination of SPARC and Intel hardware running Solaris could represent a healthy high performance solution that would possess the robust degree of homogeneity at a more economical cost.

Another alternative choice is IBM and their POWER8 platform. While POWER8 itself is a marvelous piece of hardware with outstanding performance—certainly comparable with the latest SPARC—IBM AIX is a somewhat idiosyncratic operating system that requires special knowledge to operate properly. There is no AIX for Intel, so there is no way to have a development and testing environment without buying actual AIX gear.

Database: Exemplary candidates include Postgres, DB2, Sybase, and Oracle.

Postgres is an excellent open source database with a long pedigree, high level of compliance and a rich and expressive procedural language. However, Postgres lacks a number of properties that other commercial databases have to offer: first of all, it does not have the built-in RAS features as those offered by the competition. Neither the clustering, nor the scalability, nor the level of commercial support is there. Nor does it have the intelligent auto-tuning that's available with Oracle or DB2. Yet, it is a quick and simple database that could be deployed in seconds and could perhaps be utilized as a back-end for all the schema that's peripheral to the core business or as an intermediary layer.

DB2 is a great database from IBM. It comes with a great amount of extensions and supports all relevant standards. It scales very well, although it requires a good knowledge of the system and the product to take full advantage of it. The amount of documentation can be overwhelming, and generally speaking DB2 is a product that is heavily dependent on quality experts. Many options and features available on Oracle can be done with DB2 as well. While DB2 would certainly be appropriate fit the bill, it may be overkill.

Sybase ASE is another database with a great historical pedigree—it shares a lot in common with Microsoft SQL server. It is known for excellent transactional performance and restrictive licensing. Sybase dialect of procedural SQL is somewhat peculiar and isn't readily compatible with other databases. It is also known for runtime issues with performance and sometimes stability, and requires an amount of manual intervention or at least supervision to run properly in the long run. It also does not come with a host of tools for introspection and administration on the level of Oracle or even DB2.

The last choice is Oracle RDBMS—a veteran database with almost every feature under the Sun. The downside of using Oracle is complexity and cost—it comes with a huge amount of features and tools, but those can be turned on as the need arises. Oracle comes with a native built-in horizontal scalability clustering (Oracle RAC) and replication that can allow for an active/active deployment across multiple servers and geographical locations. Furthermore, Oracle RDBMS natively integrates with Oracle TimesTen—a product they acquired—which is a 64-bit in memory database that speeds up transactional processing by a factors of almost 1000, with microsecond transactional latency. TimesTen is commonly employed in topologies similar to this—for example, financial markets OR/ME engines. Alternatively, Oracle can be tuned to use different tiers of storage to reduce transactional latency while still using ASM (automated storage manager) to reduce management complexity. It will monitor the database for abnormalities and sub-optimal performance and is capable of catching problems before they become actual problems.

### Transactional Monitor

Exemplary systems will require a transaction engine of sufficient performance and robustness. There are a few commercial products that are currently employed in high volume, low latency sensitive applications. Most known are CICS and Oracle (by way of BEA) Tuxedo. Tuxedo is a transaction monitor written in C and C++ in the 1980s, and which has been in continuous successful development and deployment since. It scales very well across the enterprise and runs very well on a wide range of platforms including Solaris and Linux. Currently it is owned by Oracle as a part of their Fusion middleware suite. It would suit the purpose well to ensure sub-millisecond transaction processing, and is well documented and supported.

### Application Server

This is the part of a solution that would host most of the features and business logic that needs to be present. There is a huge variety of application servers, with varying degrees of complexity and reliability, but only a few have been around long enough to prove robustness, scalability, reliability, ease of use and acceptable cost of ownership. The following are exemplary options:

IBM WebSphere—an excellent, hugely bloated monstrosity that comes in dozens of gigabytes of installation, thousands of pages of documentation and usually requires a full time specialist to deploy and operate in a sensitive environment. It runs on a wide range of platforms, including Linux, Solaris, Windows and AIX, and serves banks and broker/dealers well.

Apache Tomcat—a basic, bare-bones Java application server. Many commercial application servers have successfully repackaged Tomcat with add-on features and support. It is a high quality open source application with a lively development and support cycle, and there is no shortage of developers familiar with it. Drawbacks are lack of commercial entity behind it and its bare bones nature. This may not be the top-end, but is a workable option.

WebLogic—developed by the same business that owned Tuxedo for years, now WebLogic is a part of Oracle Fusion middleware. This is a product that has all the necessary enterprise features, including vertical clustering, failover, load-balancing, excellent database interconnection stack and good web-based and command-line based management tools. It is still rather complicated, but not as much as WebSphere, and its documentation and support are excellent.

### Hardware Platform

For completeness, we consider four hardware platforms that are currently under development, are mature enough, have a solid future ahead of them and support all the necessary software components. The most obvious are:

Intel Xeon (or AMD Opteron, which is fully compatible)—also known as the commodity platform. It is capable of running Linux and Solaris and is certainly the least expensive one to acquire. If one considers the offering that have same kind of business-oriented features as do other high-end platforms, cost savings become less prominent. Only 8 years ago no self-conscious systems architect would advise to put production environment on Intel servers. Reliability and scalability were nowhere near what other UNIX and Mainframe systems had to offer. During the past decade server manufacturers and Intel have been closing that gap, and by today it is certainly possible to put at least the least critical parts of the infrastructure on commodity servers. It is worth mentioning that throughput efficiency of Intel platform decreases exponentially with amount of sockets involved; cost of modern Xeon CPU and high-end RAM modules is not that competitive, so Intel-based installations make sense only when there is no immediate need for either scalability nor reliability beyond that of commodity-grade hardware. However it is also important to mention that Xeon servers and workstations are excellent candidates for running Solaris and that means that testing and development performed on them can be carried over to SPARC platform with little changes other than recompilation. Solaris is optimized to run Java application with arguably more reliability and performance than other operating systems and it has a host of features original to it that are essential to high performance and high application reliability (such as doors, zones, dtrace/mdb and ZFS)

IBM—has been very aggressive offering proprietary (POWERS) systems in combination with both their own proprietary operating systems (AIX and z/OS) as well as Linux. Their hardware is excellent if power hungry, running at very high clockspeed—even higher then Xeon—and offering a full range of enterprise features that would be expected of high-end business oriented vendor. Like many IBM products, high cost of acquisition and ownership. AIX is a UNIX operating system that is of similar level of complexity as Solaris, however there is no equivalent of AIX for commodity hardware and that would mean that all environments would need to run AIX on IBM POWER servers—a proposition that might cost significant additional monies. IBM software products usually have relatively restrictive licensing and are hard to obtain for evaluation/development purposes. IBM z/OS running on the latest incarnation of IBM z-series hardware is something to be considered, but requires significant investment.

Oracle (Sun) SPARC—via a series of acquisitions (Sun, BEA, MySQL) and strategic alliances (Fujitsu), Oracle has transformed the (somewhat stagnating) Sparc platform that has driven the Internet until the mid 2000s into an excellent business platform that has a range of middle and large scale servers that offer all the throughput, scalability and reliability a transactional business may require. Solutions that are prototyped on Solaris on Intel can be tested and deployed on the lesser models of SPARC M-series servers and production may be deployed on servers that can offer from 1 to 16 CPU sockets for a total of 32 cores per socket and 8 threads per core at 4.17 GHz frequency—that translates into up to 4096 CPU threads in a single server chassis. Hardware built-in virtualization allows to partition resources as demanded by the design requirement. That means that a single modern M7-based server can replace several racks of commodity hardware reducing complexity and cost of ownership by a magnitude and allowing unprecedented performance and flexibility. Moreover, the fact that most if not all relevant Oracle software products can be easily downloaded and used freely for development and testing purposes makes a combination of SPARC M7 hardware together with Solaris on Intel Xeon for workstation a very efficient solution. Oracle RDBMS can utilize SQL in Silicon—co-processors to 32 cores of the SPARC M7 that offload and accelerate important data functions, dramatically improving efficiency and performance of database applications. Critical functions accelerated by these new co-processors include memory de-compression, memory scan, range scan, filtering, and join assist. Offloading these functions to co-processors greatly increases the efficiency of each CPU core, lowers memory utilization, and enables up to 10× better database query performance. Oracle Database 12c In-Memory option (known as TimesTen) fully supports this new capability in the current release. Hardware security features such as Silicon Secured Memory—which adds real-time checking of access to data in memory to help protect against malicious intrusion and flawed program code in production for greater security and reliability; it is utilized by Oracle Database 12c by default and is simple and easy to turn on for existing applications; as well as Hardware-Assisted Encryption built into all M7 cores which enables uncompromised encryption use without performance penalty to have secure runtime and data for all applications even when combined with wide key usage of AES, DES, SHA, and more.

### Programming Languages

In exemplary embodiments of the present invention, any suitable programming language may be used to implement the routines of particular embodiments including C, C++, Java, JavaScript, Python, Ruby, CoffeeScript, assembly language, etc., or any equivalent. Different programming techniques may be employed such as procedural or object oriented. The routines may execute on a single processing device or multiple processors. Although the steps, operations, or computations may be presented in a specific order, this order may be changed in different particular embodiments. In some particular embodiments, multiple steps shown as sequential in this specification may be performed at the same time.

Particular embodiments may be implemented in a computer-readable storage device or non-transitory computer readable medium for use by or in connection with the instruction execution system, apparatus, system, or device. Particular embodiments may be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular embodiments may be achieved by any means as is known in the art. Distributed, networked systems, components, and/or circuits may be used. Communication, or transfer, of data may be wired, wireless, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that may be stored in a machine-readable medium, such as a storage device, to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

### APPENDIX A—EXEMPLARY USER DEVICE COMPUTER SOURCE CODE

Appendix A, provided below, presents exemplary code that may be used in an exemplary smartphone application according to embodiments of the present invention, for each of Android based smartphones and iPhone smartphones. Reference is made to Appendix A for details of such exemplary applications.

While there have been described methods for providing a user interface to a user capable of a full set of interactivity features in a variety of operational modes, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation.

1. A system for verification of payment card purchases, comprising:
a merchant card reader, communicably connected to a network;
a card issuer server, communicably connected to the network;
an application server communicably connected to at least one of the merchant card reader and the card issuer server; and
a user device provided with an application, wherein parameters may be set, wherein, in operation, when a payment card is submitted to the merchant, and the transaction is within the parameters for approval, the user device receives and displays a request for approval of the transaction from a user.

2. The system of claim 1, wherein when the transaction is within the parameters for approval the merchant device sends an approval request to either:
the card issuer server, which in turn sends a request to the application server, which queries the user device, or
directly to the application server, which queries the user device.

3. The system of claim 1, wherein at least one of:
the card issuer server and the application server are integrated;
or
the card issuer server and the application server are integrated and when the transaction is within the parameters for approval the merchant device sends an approval request to the integrated card issuer server and application server, which queries the user device.

4. (canceled)

5. The system of claim 1, wherein at least one of:
the parameters may exclude certain transactions from requiring user approval, or may include certain transactions as requiring user approval;
the parameters are set by a user, via a user interface displayed by the application on the user device;
the parameters have default values, some or all of which being modifiable by a user;
or
the parameters include one or more of the transaction (i) exceeding a defined dollar amount, (ii) originating in a defined store, (iii) originating in a defined geographical area, (iv) occurring after a defined daily maximum for the card has been reached, (v) exceeding a daily maximum for the card by a defined amount, (vi) being made online, where the purchaser merely submits card information, (vii) being made by reading the payment card without the user having to physically present it to a merchant, and (viii) being made by a non-primary user of the payment card account.

6-8. (canceled)

9. A system for verification of payment card purchases, comprising:
one or more processors; and one or more memories containing instructions that, when executed, cause the one or more processors to:
receive a request for a payment card transaction for a user account with a card issuer, and associated transaction data;
retrieve a set of parameters for the payment card;
determine if the parameters, given the associated transaction data, require the card holder to approve the transaction; and
in response to a positive determination, send a request message to a user device for approval of the transaction.

10. The system of claim 9, wherein the instructions, when executed, further cause the one or more processors to:
in response to a user approving the transaction, sending an approval response and finalizing the transaction;

11. The system of claim 9, wherein at least one of:
the request is received at a merchant payment system, and the parameters retrieved and the determination made at one of: the merchant payment system, a card issuer server, and an application server;
the request is received at a merchant payment system, and the parameters retrieved and the determination made at one of: the merchant payment system, a card issuer server, and an application server, and the application server is integrated with either the card issuer server or the merchant payment system;
the request is received at a merchant payment system, and the parameters retrieved and the determination made at a card issuer server, which sends a request to an application server which interfaces with the user device;
the user device also provides an advertising message to the user;
the client device is one or more of: a smart phone, mobile phone, tablet computer, personal digital assistant, laptop computer, desktop computer, and digital music player;
the request is received at a merchant payment system, and the parameters retrieved and the determination made at an application server which interfaces with the user device;
or
the request is received at a merchant payment system, the parameters retrieved and the determination made at an application server which interfaces with the user device, a separate request for approval is sent in parallel to a card issuer sever, which implements its own transaction approval criteria, and the instructions further cause the one or more processors to approve the transaction only if an approval response is received from both the user and the card issuer.

12-18. (canceled)

19. The system of claim 9, wherein if the user does not respond to the request message in a defined first time, at least one of:
sending the request to an email address of the user, sending the request to the user via SMS, resending the request message to the user device, and denying the transaction after a defined second time.

20. The system of claim 9, wherein statistics are stored for each transaction for which user approval was sought, and the response to the approval request.

21. The system of claim 21, wherein at least one of:
the instructions further cause the one or more processors to analyze the statistics to define or modify at least one of fraudulent use profiles and non-fraudulent use profiles;
or
the instructions further cause the one or more processors to utilize the profiles to set of modify default sets of parameters.

22. (canceled)

23. A method for verification of payment card purchases, comprising:
receiving a request for a payment card transaction for a user account with a card issuer, and associated transaction data;
retrieving a set of parameters for the payment card; determining if the parameters, given the associated transaction data, require input from a user device; and
in response to a positive determination, sending a request message to a user device.

24. The method of claim 23, wherein at least one of:
the input from the user device is one of (i) GPS co-ordinates or (ii) manual approval of the transaction;
the input from the user device is manual approval of the transaction, and wherein in response to a user approving the transaction, sending an approval response and finalizing the transaction;
the request is received at a merchant payment system, and the parameters are retrieved and the determination is made at one of: the merchant payment system, a card issuer server, and an application server;
the request is received at a merchant payment system, and the parameters are retrieved and the determination is made at one of: the merchant payment system, a card issuer server, and an application server, and the application server is integrated with either the card issuer server or the merchant payment system;
the request is received at a merchant payment system, and the parameters retrieved and the determination made at a card issuer server, which sends a request to an application server which interfaces with the user device;
or
the input from the user device is manual approval of the transaction, and wherein in response to a user approving the transaction, sending an approval response and finalizing the transaction, and the user device also provides an advertising message to the user.

25-29. (canceled)

30. The method of claim 23, wherein the user device is one or more of: a smart phone, mobile phone, tablet computer, personal digital assistant, laptop computer, desktop computer, and digital music player.

31. The method of claim 23, wherein the request is received at a merchant payment system, and the parameters retrieved and the determination made at an application server which interfaces with the user device.

32. The method of claim 31, wherein a separate request for approval is sent in parallel to a card issuer sever, which implements its own transaction approval criteria.

33. The method of claim 32, wherein the instructions further cause the one or more processors to approve the transaction only if an approval response is received from both the user and the card issuer.

34. The method of claim 23, wherein if the user does not respond to the request message in a defined first time interval, at least one of:
sending the request to an email address of the user, sending the request to the user via SMS, resending the request message to the user device, and denying the transaction after a defined second time.

35. The method of claim 23, wherein at least one of:
statistics are stored for each transaction for which user approval was sought, and the response to the approval request;
statistics are stored for each transaction for which user approval was sought, and the response to the approval request, the method further comprising analyzing the statistics to define or modify at least one of fraudulent use profiles and non-fraudulent use profiles;
or
statistics are stored for each transaction for which user approval was sought, and the response to the approval request, the method further comprising utilizing the profiles to set or modify default sets of parameters.

36-37. (canceled)
